(19) United States
(12) Patent Application Publication
(10) Pub. No.: US 2025/0331058 A1
(43) Pub. Date: Oct. 23, 2025

(54) Wireless Communication Method and Device Thereof

(71) Applicant: ZTE CORPORATION, Shenzhen, Guangdong (CN)

(72) Inventors: Xiaoying MA, Shenzhen (CN); Mengzhu CHEN, Shenzhen (CN); Jun XU, Shenzhen (CN); Bo DAI, Shenzhen (CN); Hong TANG, Shenzhen (CN); Jianqiang DAI, Shenzhen (CN)

(21) Appl. No.: 18/857,771

(22) PCT Filed: Apr. 21, 2022
(86) PCT No.: PCT/CN2022/088315

§ 371 Date: Oct. 17, 2024

(51) Int. Cl. H04W 76/28; H04W 52/02; H04W 72/232

(52) U.S. Cl. CPC H04W 76/28; H04W 52/0216; H04W 72/232

(57) ABSTRACT

A wireless communication method for use in a wireless terminal is disclosed. The method comprises performing a discontinuous reception (DRX) to monitor a physical downlink control channel (PDCCH), determining a starting position of an on-duration timer for a next DRX cycle according to at least one of a first signaling or to a predefined condition, and activating the on-duration timer at the determined starting position, wherein the first signaling is monitored in a time period.

### CROSS REFERENCE TO RELATED APPLICATION(S)

This application is a national phase entry under 35 USC 371 of International Patent Application No. PCT/CN2022/088315 filed on Apr. 21, 2022, and claims a priority to the International Patent Application, and the entire content of the International Patent Application is incorporated herein by reference.

### TECHNICAL FIELD

This document is directed generally to wireless communications, in particular to 5G communications.

### BACKGROUND

Discontinuous reception (DRX) is a power saving technique. The basic mechanism of the DRX is configuring a DRX cycle for the UE, where a drx-onDurationTimer begins one DRX cycle. During the drx-onDurationTimer, the UE is in a DRX On state and continues monitoring a physical downlink control channel (PDCCH) and if the UE successfully decodes a PDCCH the UE stays awake (i.e. in the DRX On state) and starts an inactivity timer. The UE may go to sleep (i.e. be in a DRX off state (i.e. opportunity for DRX shown in FIG. 1) after the drx-onDurationTimer or the drx-inactivityTimer expires. In the DRX off state, the UE does not monitor the PDCCH.

The DRX On state or UE stays awake means that the UE is in an active time. When the DRX is configured, the Active Time for Serving Cells in a DRX group includes the time while:
drx-onDurationTimer or drx-InactivityTimer configured for the DRX group is running; or
drx-RetransmissionTimerDL or drx-RetransmissionTimerUL is running on any Serving Cell in the DRX group; or
ra-ContentionResolutionTimer or msgB-ResponseWindow is running; or
a Scheduling Request is sent on physical uplink control channel (PUCCH) and is pending; or
a physical downlink control channel (PDCCH) indicating a new transmission addressed to a cell radio network temporary identifier (C-RNTI) of a media access control (MAC) entity has not been received after a successful reception of a Random Access Response for the Random Access Preamble not selected by the MAC entity among the contention-based Random Access Preambles.

The DRX off state or a sleep state or the DRX off period means that the UE is not in active time or outside of the active time.

With the development of wireless communication technology, the transmission rate, delay, throughput, reliability and other performance indexes of a wireless communication system have been greatly improved by using high frequency band, large bandwidth, multi-antenna and other technologies. The extended Reality (XR) and Cloud Gaming are some of the most important 5G media applications under considerations in the industry. The XR includes representative forms such as Augmented Reality (AR), Mixed Reality (MR) and Virtual Reality (VR) and areas interpolated among them. The traffic of XR includes video, audio, pose/control, etc. The 5G services (e.g., XR and Cloud Gaming service) need high reliability, high throughput and low latency. Since the devices used for the XR include a Head-Mounted Display or glasses with standalone capability, the battery life of the XR devices has a great impact on user equipment (UE) experience. Therefore, how to reduce UE power consumption is an important topic to be discussed.

### SUMMARY

The present disclosure relates to a wireless communication method for use in a wireless terminal. The method comprises:
performing a discontinuous reception, DRX, to monitor a physical downlink control channel, PDCCH, determining a starting position of an on-duration timer for a next DRX cycle according to at least one of a first signaling or to a predefined condition, and activating the on-duration timer at the determined starting position, wherein the first signaling is monitored in a time period.

Various embodiments may preferably implement the following features.

Preferably, the time period is determined by a monitoring period indicating a cycle of the first signaling.

Preferably, the time period is determined by at least one of a first reference point, a first offset, a second reference point, a second offset, a window length, a timer, a jitter window, a jitter value, a packet delay budget, PDB, a traffic information, a minimum time gap, or a monitoring pattern.

Preferably, a start of the time period is determined based on a first reference point and a first offset, and the first offset indicates a time duration between the starting point of the time period and the first reference point.

Preferably, the first reference point comprises at least one of: a beginning of a slot or a subframe or a millisecond at where the on-duration timer for the next DRX cycle starts, a last slot where the on-duration timer or an inactivity timer or a retransmission timer of the DRX expires, a system frame where the beginning of the slot at where the on-duration timer for the next DRX cycle starts, a system frame where a last slot of the on-duration timer or an inactivity timer of the DRX expires, X-th subframe of every Y-th system frame, where X is an integer greater than or equal to 0 and smaller than 10 and Y is an integer greater than or equal to 0 and smaller than 513, a system frame, a beginning of a system frame, an end of a system frame, an end of a slot at where the on-duration timer for the next DRX cycle starts, a slot or a subframe of a start of a jitter window, a slot or a subframe of an end of a jitter window, or a slot or a subframe of a middle of a jitter window.

Preferably, the first offset is one of: a value smaller than or equal to half of the PDB, a value associated with a PDB value, a value associated with a traffic parameter in the traffic information, a value associated with a frames per second value, a value associated with a length of jitter window, a value associated with a Protocol Data Unit, PDU, set, a value associated with a quality indicator of PDU set, a value associated with a quality of service parameter, a value associated with a traffic periodicity in the traffic information, a value smaller than or equal to half of a traffic periodicity comprised in the traffic information, a value smaller than or equal to a quotient of a division of 1000 by a frames per second parameter comprised in the traffic information.

Preferably, the first offset has different values for different values of a quality of service parameter or a priority parameter comprised in the traffic information.

Preferably, an end of the time period is determined based on at least one of a second reference point, a second offset, a minimum time gap, a window length, a jitter range, a jitter window, or a number of monitor occasions of the first signaling.

Preferably, the second reference point comprises at least one of: a beginning of a slot or a subframe or a millisecond where the on-duration timer for the next DRX cycle starts, a last slot where the on-duration timer or an inactivity timer or a retransmission timer of the DRX expires, a system frame where a beginning of the slot at where the on-duration timer for the next DRX cycle starts; a system frame after a last slot before the on-duration timer or an inactivity timer of the DRX expires, X-th subframe of every Y-th system frame, where X is an integer greater than or equal to 0 and smaller than 10 and Y is an integer greater than or equal to 0 and smaller than 513, a system frame, a beginning of a system frame, an end of a system frame, an end of a slot at where the on-duration timer for the next DRX cycle starts, a slot or subframe of a start of the jitter window, a slot or subframe of a middle of the jitter window, a slot or subframe of an end of the jitter window.

Preferably, the end of the time period is determined by the second reference point and the second offset and the second offset indicates a time duration between the second reference point and the end of the time period.

Preferably, the end of the time period is determined by the window length indicating a time duration from a start of the time period to the end of the time period.

Preferably, the window length is associated with at least one of: a packet delay budget, PDB, a jitter range, a quality indicator of a protocol data unit set, or traffic information.

Preferably, the wireless communication method further comprises stopping monitoring the first signaling after monitoring a fixed number of monitoring occasions of the first signaling.

Preferably, a unit of the time period is a slot or a millisecond.

Preferably, the wireless communication method further comprises monitoring the first signaling in the time period according to a monitoring pattern.

Preferably, the monitoring pattern indicates a monitoring cycle, wherein monitoring the first signaling in the time period according to the monitoring pattern comprises: monitoring the first signaling in a time-domain position if (SFN*10+subframe number) mod (monitoring cycle)=I, where SFN is a system frame number corresponding to the time-domain position, subframe number is a subframe index corresponding to the time-domain position, and I is an integer greater than or equal to 0 and smaller than the monitoring cycle.

Preferably, the monitoring pattern comprises a bitmap, wherein each bit in the bitmap indicate whether at least one time interval in the time period is valid for monitoring the first signaling, wherein monitoring the first signaling in the time period according to the monitoring pattern comprises: monitoring the first signaling in a valid time interval.

Preferably, the first signaling is downlink control information, DCI, a sequence based signaling or a reference signal.

Preferably, the first signaling comprises indication information for at least one of: whether to start the on-duration timer, whether to start the on-duration timer after a time duration, a time duration associated with starting the on-duration timer based on the first signaling or in response to the predefined condition, a temporary offset used to determine when to start the on-duration timer, a change offset used to determine a start offset associated with the on-duration timer, when to start the on-duration timer, or a search space set group index.

Preferably, the time duration is a predefined value, indicated by the first signaling or configured by a high layer signaling.

Preferably, the time duration is associated with a sub-carrier spacing, is a minimum time gap, is a second offset used for determining the time period or is 0.

Preferably, the high layer signaling configures a list of candidate values for the time duration.

Preferably, the first signaling is DCI and is associated with at least one configuration parameter comprising at least one of a search space set, a radio network temporary identifier, RNTI, a start position of the indication information of the first signaling, a DCI size of the first signaling, an enable signaling, a quasi-co-location, QCL, or a transmission configuration indicator, TCI, state.

Preferably, the at least one configuration parameter is configured by a high layer signaling.

Preferably, the at least one configuration parameter of the search space set is limited by at least one of: the number of search space sets used for the first signaling is not larger than a first threshold, wherein the first threshold is an integer greater than 0 and smaller than 3, a duration of the search space set used for the first signaling is not larger than a second threshold, wherein the second threshold is an integer greater than 0 and smaller than 30, a periodicity of the search space set used for the first signaling is not smaller than a third threshold, wherein the third threshold is an integer greater than 1, a number of aggregation levels of the search space set used for the first signaling is not larger than a fourth threshold, wherein the fourth threshold is an integer greater than 0 and smaller than 3, a maximum of an aggregation level of the search space set used for the first signaling is not larger than a fifth threshold, wherein the fifth threshold is an integer greater than 0 and smaller than 8, a number of PDCCH candidates per aggregation level of the search space set used for the first signaling is not larger than a sixth threshold, wherein the sixth threshold has the same value or different values for different aggregation levels, a total number of PDCCH candidates of the search space set used for the first signaling is not larger than a seventh threshold, wherein the seventh threshold is an integer greater than 0 and smaller than 20, or a number of monitoring occasions in single slot of the search space set used for the first signaling is not larger than an eighth threshold, wherein the eighth threshold is an integer greater than 0 and less than 3.

Preferably, the RNTI is used for at least one of: DCI associated with traffics of an extended reality service, DCI associated with an extended reality service, DCI indicating whether there is a traffic of extended reality service for the next DRX long cycle, DCI indicating whether to start the on-duration timer, DCI indicating whether to start the on-duration timer after the time duration, DCI indicating a time duration, a temporary offset or a change offset, DCI indicating whether to change a start offset associated with the on-duration timer, or DCI indicating whether to monitor the DCI in a subsequent monitoring occasion.

Preferably, if the first signaling is configured: a number of sizes of DCI formats for PDCCH candidates in the serving cell is up to 5, and a number of sizes of DCI formats having a cyclic redundancy check scrambled by a cell radio network temporary identifier in the serving cell is up to 3.

Preferably, at least one of the starting position of the indication information in the first signaling or a DCI size of the first signaling is indicated by a high layer signaling, and one or more bits in a block in the first signaling indicates the indication information for one or more wireless terminals in a group.

Preferably, the first signaling is DCI format 2_6 scrambled with the RNTI.

Preferably, different monitor occasions for the first signaling in a time interval are associated with a plurality of transmission relations.

Preferably, the time interval comprises at least one search space set cycle, at least one slot, or the time period.

Preferably, each monitor occasion comprises one or more consecutive slots, one or more consecutive symbols, or one or more consecutive search space set cycles.

Preferably, one or more consecutive monitor occasions are grouped as a monitor occasion group associated with the same transmission relation.

Preferably, each monitor occasion or each monitor occasion group is configured, by a high layer signaling, to be associated with a transmission relation.

Preferably, the transmission relation associated with each monitor occasion or each monitor occasion group is determined based on a transmission relation list configured in a search space set of the first signaling.

Preferably, the monitor occasions in one time interval are divided into X groups, wherein X is the number of transmission relations in the transmission relation list.

Preferably, a first monitor occasion in the time interval is associated with a first transmission relation of a search space set of the first signaling and the remaining monitor occasions in the time interval are associated with at least one second transmission relation different from the first transmission relation.

Preferably, the transmission relation is associated with at least one of a quasi-co-location, a control resource set, CORESET, a transmission configuration indicator, TCI state, or a synchronization signal block.

Preferably, the wireless communication method further comprises monitoring the first signaling if at least one of the following conditions exists: at least part of the time period is outside of an active time of the DRX, a search space is configured for the first signaling, receiving, from the wireless network, an enable signaling or an activation signaling monitoring the first signaling, outside of an active time of the DRX, within the time period, another first signaling indicating continuing to monitor the first signaling was received, or not receiving the first signaling which indicates starting the on-duration timer after a time duration.

Preferably, there is no available monitor occasion of the first signaling for the next DRX cycle, and the wireless communication method further comprises starting the on-duration timer for the next DRX cycle after a time duration.

Preferably, the predefined condition comprises at least one of: not detecting the first signaling indicating starting the on-duration timer after a time duration during the time period, receiving an enable signaling for enabling changing a start offset of the on-duration timer, receiving an enable signaling for enabling monitoring the first signaling, reporting a capability signaling indicating a support of monitoring the first signaling, a timer expires, wherein the timer is triggered under at least one of following conditions: if receiving scheduling DCI, if receiving scheduling DCI for XR service traffic, if receiving the first signaling, if receiving a first kind of DCI format, at a first slot outside of an active time of the DRX, or at a first slot after the on-duration timer or an inactivity timer expires, the timer expires and not receiving a traffic during the timer running, receiving a first kind of DCI format, wherein the first kind of DCI format includes at least one of: a DCI used for XR service traffic, a DCI format 0_1, a DCI format 1_1, a DCI format 0_2, a DCI format 1_2, or a DCI format 2_6, receiving DCI scrambled with a first kind of RNTI, wherein the first kind of RNTI includes at least one of: an RNTI used for DCI associated with traffics of an extended reality service, an RNTI used for DCI indicating whether to start the on-duration timer, an RNTI used for DCI indicating whether to start the on-duration timer after the time duration, an RNTI used for DCI indicating whether to change a start offset associated with the on-duration timer, an RNTI used for DCI indicating whether to monitor the DCI in a subsequent monitoring occasion, a power saving RNTI, a cell RNTI, a configured scheduling RNTI, or a modulation and coding scheme cell RNTI.

Preferably, determining the starting position of the on-duration timer for the next DRX cycle according to the first signaling comprises: determining the starting position of the on-duration timer for the next DRX cycle based on the indication information in the first signaling, or determining the starting position of the on-duration timer for the next DRX cycle is after a time duration after the slot or subframe in which receiving the first signaling.

Preferably, determining the starting position of the on-duration timer for the next DRX cycle according to a predefined condition comprises: determining the starting position of the on-duration timer for the next DRX cycle is after the time duration after the slot or subframe where the predefined condition is satisfied.

Preferably, the predefined condition comprises not detecting the first signaling indicating starting the on-duration timer after a time duration during the time period, wherein the starting position of the on-duration timer for the next DRX cycle is determined based on the first signaling or is determined as the time duration after receiving the first signaling if the first signaling indicating starting the on-duration timer after a time duration is detected in the time period, and wherein the starting position of the on-duration timer for the next DRX cycle is determined based on a DRX configuration of the DRX if the predefined condition is satisfied.

Preferably, the predefined condition comprises receiving an enable signaling for enabling changing a start offset of the on-duration timer or for enabling monitoring the first signaling, wherein the starting position is determined by: if the first signaling indicating starting the on-duration timer after a duration is detected in the time period and the predefined condition is satisfied, the starting position of the on-duration timer for the next DRX cycle is determined based on the first signaling or is determined to be after the time duration after receiving the first signaling, otherwise, the starting position of the on-duration timer for the next DRX cycle is determined based on a DRX configuration of the DRX.

The present disclosure relates to a wireless communication method for use in a wireless network node. The method comprises:
transmitting, to a wireless terminal, a first signaling in a time period, wherein the first signaling is associated with determining a starting position of an on-duration timer of a discontinuous reception, DRX.

Various embodiments may preferably implement the following features.

Preferably, the time period is determined by a monitoring period indicating a cycle of the first signaling.

Preferably, the time period is determined by at least one of a first reference point, a first offset, a second reference point, a second offset, a window length, a timer, a jitter window, a jitter value, a packet delay budget, PDB, a traffic information, a minimum time gap, or a monitoring pattern.

Preferably, a start of the time period is determined based on a first reference point and a first offset, and the first offset indicates a time duration between the starting point of the time period and the first reference point.

Preferably, the first reference point comprises at least one of: a beginning of a slot or a subframe or a millisecond at where the on-duration timer for the next DRX cycle starts, a last slot where the on-duration timer or an inactivity timer or a retransmission timer of the DRX expires, a system frame where the beginning of the slot at where the on-duration timer for the next DRX cycle starts, a system frame where a last slot of the on-duration timer or an inactivity timer of the DRX expires, X-th subframe of every Y-th system frame, where X is an integer greater than or equal to 0 and smaller than 10 and Y is an integer greater than or equal to 0 and smaller than 513, a system frame, a beginning of a system frame, an end of a system frame, an end of a slot at where the on-duration timer for the next DRX cycle starts, a slot or a subframe of a start of a jitter window, a slot or a subframe of an end of a jitter window, or a slot or a subframe of a middle of a jitter window.

Preferably, the first offset is one of: a value smaller than or equal to half of the PDB, a value associated with a PDB value, a value associated with a traffic parameter in the traffic information, a value associated with a frames per second value, a value associated with a length of jitter window, a value associated with a Protocol Data Unit, PDU, set, a value associated with a quality indicator of PDU set, a value associated with a quality of service parameter, a value associated with a traffic periodicity in the traffic information, a value smaller than or equal to half of a traffic periodicity comprised in the traffic information, a value smaller than or equal to a quotient of a division of 1000 by a frames per second parameter comprised in the traffic information.

Preferably, the first offset has different values for different values of a quality of service parameter or a priority parameter comprised in the traffic information.

Preferably, an end of the time period is determined based on at least one of a second reference point, a second offset, a minimum time gap, a window length, a jitter range, a jitter window, or a number of monitor occasions of the first signaling.

Preferably, the second reference point comprises at least one of: a beginning of a slot or a subframe or a millisecond where the on-duration timer for the next DRX cycle starts, a last slot where the on-duration timer or an inactivity timer or a retransmission timer of the DRX expires, a system frame where a beginning of the slot at where the on-duration timer for the next DRX cycle starts; a system frame after a last slot before the on-duration timer or an inactivity timer of the DRX expires, X-th subframe of every Y-th system frame, where X is an integer greater than or equal to 0 and smaller than 10 and Y is an integer greater than or equal to 0 and smaller than 513, a system frame, a beginning of a system frame, an end of a system frame, an end of a slot at where the on-duration timer for the next DRX cycle starts, a slot or subframe of a start of the jitter window, a slot or subframe of a middle of the jitter window, a slot or subframe of an end of the jitter window.

Preferably, the end of the time period is determined by the second reference point and the second offset and the second offset indicates a time duration between the second reference point and the end of the time period.

Preferably, the end of the time period is determined by the window length indicating a time duration from a start of the time period to the end of the time period.

Preferably, the window length is associated with at least one of: a packet delay budget, PDB, a jitter range, a quality indicator of a protocol data unit set, or traffic information.

Preferably, a unit of the time period is a slot or a millisecond.

Preferably, transmitting, to the wireless terminal, the first signaling in the time period comprises: transmitting, to the wireless terminal, the first signaling in the time period according to a monitoring pattern.

Preferably, the monitoring pattern indicates a monitoring cycle, wherein transmitting, to the wireless terminal, the first signaling in the time period according to the monitoring pattern comprises: transmitting, to the wireless terminal, the first signaling in a time-domain position if (SFN*10+subframe number) mod (monitoring cycle)=I, where SFN is a system frame number corresponding to the time-domain position, subframe number is a subframe index corresponding to the time-domain position, and I is an integer greater than or equal to 0 and smaller than the monitoring cycle.

Preferably, the monitoring pattern comprises a bitmap, wherein each bit in the bitmap indicate whether at least one time interval in the time period is valid for monitoring the first signaling, wherein transmitting, to the wireless terminal, the first signaling in the time period according to the monitoring pattern comprises: transmitting, to the wireless terminal, the first signaling in a valid time interval.

Preferably, the first signaling is downlink control information, DCI, a sequence based signaling or a reference signal.

Preferably, the first signaling comprises indication information for at least one of: whether to start the on-duration timer, whether to start the on-duration timer after a time duration, a time duration associated with starting the on-duration timer based on the first signaling or in response to the predefined condition, a temporary offset used to determine when to start the on-duration timer, a change offset used to determine a start offset associated with the on-duration timer, when to start the on-duration timer, or a search space set group index.

Preferably, the time duration is a predefined value, indicated by the first signaling or configured by a high layer signaling.

Preferably, the time duration is associated with a sub-carrier spacing, is a minimum time gap, is a second offset used for determining the time period or is 0.

Preferably, the high layer signaling configures a list of candidate values for the time duration.

Preferably, the first signaling is DCI and is associated with at least one configuration parameter comprising at least one of a search space set, a radio network temporary identifier, RNTI, a start position of the indication information of the first signaling, a DCI size of the first signaling, an enable signaling, a quasi-co-location, QCL, or a transmission configuration indicator, TCI, state.

Preferably, the at least one configuration parameter is configured by a high layer signaling.

Preferably, the at least one configuration parameter of the search space set is limited by at least one of: the number of search space sets used for the first signaling is not larger than a first threshold, wherein the first threshold is an integer greater than 0 and smaller than 3, a duration of the search space set used for the first signaling is not larger than a second threshold, wherein the second threshold is an integer greater than 0 and smaller than 30, a periodicity of the search space set used for the first signaling is not smaller than a third threshold, wherein the third threshold is an integer greater than 1, a number of aggregation levels of the search space set used for the first signaling is not larger than a fourth threshold, wherein the fourth threshold is an integer greater than 0 and smaller than 3, a maximum of an aggregation level of the search space set used for the first signaling is not larger than a fifth threshold, wherein the fifth threshold is an integer greater than 0 and smaller than 8, a number of PDCCH candidates per aggregation level of the search space set used for the first signaling is not larger than a sixth threshold, wherein the sixth threshold has the same value or different values for different aggregation levels, a total number of PDCCH candidates of the search space set used for the first signaling is not larger than a seventh threshold, wherein the seventh threshold is an integer greater than 0 and smaller than 20, or a number of monitoring occasions in single slot of the search space set used for the first signaling is not larger than an eighth threshold, wherein the eighth threshold is an integer greater than 0 and less than 3.

Preferably, the RNTI is used for at least one of: DCI associated with traffics of an extended reality service, DCI associated with an extended reality service, DCI indicating whether there is a traffic of extended reality service for the next DRX long cycle, DCI indicating whether to start the on-duration timer, DCI indicating whether to start the on-duration timer after the time duration, DCI indicating a time duration, a temporary offset or a change offset, DCI indicating whether to change a start offset associated with the on-duration timer, or DCI indicating whether to monitor the DCI in a subsequent monitoring occasion.

Preferably, if the first signaling is configured: a number of sizes of DCI formats for PDCCH candidates in the serving cell is up to 5, and a number of sizes of DCI formats having a cyclic redundancy check scrambled by a cell radio network temporary identifier in the serving cell is up to 3.

Preferably, at least one of the starting position of the indication information in the first signaling or a DCI size of the first signaling is indicated by a high layer signaling, and one or more bits in a block in the first signaling indicates the indication information for one or more wireless terminals in a group.

Preferably, the first signaling is DCI format 2_6 scrambled with the RNTI.

Preferably, different monitor occasions for the first signaling in a time interval are associated with a plurality of transmission relations.

Preferably, the time interval comprises at least one search space set cycle, at least one slot, or the time period.

Preferably, each monitor occasion comprises one or more consecutive slots, one or more consecutive symbols, or one or more consecutive search space set cycles.

Preferably, one or more consecutive monitor occasions are grouped as a monitor occasion group associated with the same transmission relation.

Preferably, each monitor occasion or each monitor occasion group is configured, by a high layer signaling, to be associated with a transmission relation.

Preferably, the transmission relation associated with each monitor occasion or each monitor occasion group is determined based on a transmission relation list configured in a search space set of the first signaling.

Preferably, the monitor occasions in one time interval are divided into X groups, wherein X is the number of transmission relations in the transmission relation list.

Preferably, a first monitor occasion in the time interval is associated with a first transmission relation of a search space set of the first signaling and the remaining monitor occasions in the time interval are associated with at least one second transmission relation different from the first transmission relation.

Preferably, the transmission relation is associated with at least one of a quasi-co-location, a control resource set, CORESET, a transmission configuration indicator, TCI state, or a synchronization signal block.

The present disclosure relates to a wireless terminal. The wireless terminal comprises: a communication unit, and a processor, configured to use the communication unit to perform a discontinuous reception, DRX, to monitor a physical downlink control channel, PDCCH, determine a starting position of an on-duration timer for a next DRX cycle according to at least one of a first signaling or to a predefined condition, and activate the on-duration timer at the determined starting position, wherein the first signaling is monitored in a time period.

Various embodiments may preferably implement the following feature.

Preferably, the processor is further configured to perform any of aforementioned wireless communication methods.

The present disclosure relates to a wireless network node. The wireless network node comprises a communication unit, configured to transmit, to a wireless terminal, a first signaling in a time period, wherein the first signaling is associated with determining a starting position of an on-duration timer of a discontinuous reception, DRX.

Various embodiments may preferably implement the following feature.

Preferably, the wireless network node further comprises a processor configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of the DRX.

FIG. 2 shows a schematic diagram of a wake-up signal according to an embodiment of the present disclosure.

FIG. 3 shows a schematic diagram of the time window according to an embodiment of the present disclosure.

FIG. 4 shows a schematic diagram of the time window according to an embodiment of the present disclosure.

FIG. 5 shows a schematic diagram of the time window according to an embodiment of the present disclosure.

FIG. 6 shows a schematic diagram of the monitoring pattern according to an embodiment of the present disclosure.

FIG. 7 shows a schematic diagram of the monitor occasion of the first signaling according to an embodiment of the present disclosure.

FIG. 8 shows a schematic diagram of the monitor occasion of the first signaling according to an embodiment of the present disclosure.

FIG. 9 shows a schematic diagram of the time window according to an embodiment of the present disclosure.

FIG. 10 shows a schematic diagram of the time window according to an embodiment of the present disclosure.

FIG. 11 shows an example of a schematic diagram of a wireless terminal according to an embodiment of the present disclosure.

FIG. 12 shows an example of a schematic diagram of a wireless network node according to an embodiment of the present disclosure.

FIGS. 13 and 14 are flowcharts of methods according to embodiments of the present disclosure.

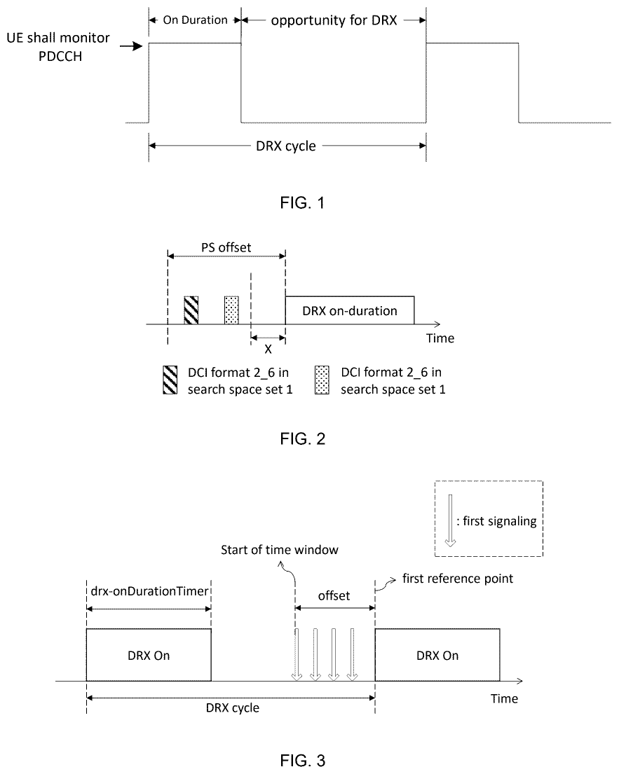

### DETAILED DESCRIPTION

In the present disclosure, the drx-onDurationTimer may be called on-duration timer or onDurationTimer.

In the present disclosure, the DRX On state may be equal to DRX on period or DRX on duration.

In the present disclosure, long DRX cycle may be equal to DRX long cycle.

In the present disclosure, the monitor occasion may be equal to monitoring occasions.

In the present disclosure, the DRX off state or a sleep state or the DRX off period means that the UE is not in active time or outside of the active time.

In the present disclosure, the drx-startoffset may be equal to start offset or startoffset.

FIG. 2 shows a schematic diagram of a wake-up signal (WUS) according to an embodiment of the present disclosure.

In FIG. 2, downlink control information downlink control information (DCI) format 2_6 is used to indicate whether a UE starts the drx-onDurationTimer for a next DRX long cycle. For example, ‘0’ means not start and ‘1’ means start.

In addition, PS-offset indicates a time, where the UE starts monitoring PDCCH for detection of the DCI format 2_6 according to the number of search space sets, prior to a slot where the drx-onDurationTimer would start on a primary cell (PCell) or on a secondary primary cell (SpCell).

If the UE reports for an active DL BWP a MinTimeGap value that is X slots prior to the beginning of a slot where the UE would start the drx-onDurationTimer, the UE is not required to monitor the PDCCH for detection of the DCI format 2_6 during the X slots, where X corresponds to the MinTimeGap value of a sub-carrier spacing (SCS) of the active DL BWP in the following Table 1.

TABLE 1
Minimum time gap value X

Minimum Time Gap X
(slots)

| SCS (kHz) | Value 1 | Value 2 |
|---|---|---|
| 15 | 1 | 3 |
| 30 | 1 | 6 |
| 60 | 1 | 12 |
| 120 | 2 | 24 |
| 480 | 8 | 96 |
| 960 | 16 | 192 |

In FIG. 2, the occasion for UE to monitor the DCI format 2_6 is determined by PS-offset and minimum time gap value X.

In an embodiment of the WUS, the UE does not monitor the PDCCH for detecting the DCI format 2_6 during active time (e.g. DRX On duration/state/period).

The present disclosure provides methods to reduce the UE power consumption. In addition, the signal overhead of signal is reduced. Furthermore, the power used to monitor the signal is also reduced. The methods provided in the present disclosure also have good backward compatibility.

In the following, the operation at the UE side is illustrated.

In an example, the UE performs the DRX to monitor the PDCCH. In this example, the UE determines a position of a start of a drx-onDurationTimer according to at least one of a first signaling or a predefined condition and starts the drx-onDurationTimer at the determined position. The first signaling may be monitored during a specific time period/window. Note that in some embodiments the term “time period” is used and in other embodiments the term “time window” is used. In the present disclosure, the time period may be equal to the time window.

In an example, the UE may need to determine when to monitor the first signaling. For example, the time period/window is a time duration where the UE monitors the first signaling. The time window is determined according to at least one of: a first reference point, a first offset, a second reference point, a second offset, a window length, a timer, a jitter range/window, a jitter value, a PDB (packet delay budget), a traffic information, a minimum time gap, a monitoring pattern. In some embodiments, these parameters are called time window parameters or first signaling parameters.

In an example, the time window parameter includes a monitoring period. The monitoring period indicates a cycle/period of the first signaling.

In some embodiments, at least one of the first reference point, the second reference point, the second offset and the minimum time gap is predefined.

In some embodiments, at least one of the first offset, the second offset, the window length, the timer, the jitter range/window, the jitter value, the PDB, the traffic information, the minimum time gap, and the monitoring period is configured by a high layer signaling. In some embodiments, a high layer signaling is at least a media access control control element (MAC CE) signaling or an RRC signaling.

In an example, the start of the time window is associated with the first reference point. For example, the time window starts at a time instant which is a slot, a subframe, a millisecond, a system frame after (e.g. next to) the first reference point.

In an example, the start of the time window is associated with the first reference point and the first offset. The first offset is a time duration between a slot of the start of the time window and the slot of the first reference point.

FIG. 3 shows a schematic diagram of the time window according to an embodiment of the present disclosure. In FIG. 3, the first reference point is a slot (e.g. 1st slot) where the UE would start the drx-onDurationTimer (e.g. start of the DRX On duration/period/state). The start of the time window is the (first) offset before the first reference point in this embodiment.

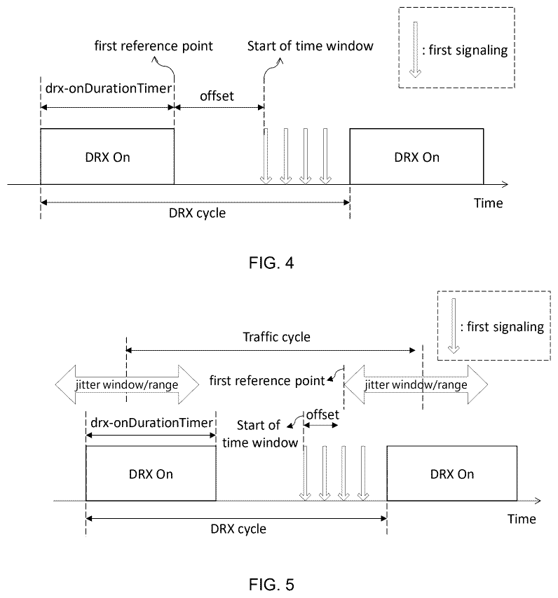

FIG. 4 shows a schematic diagram of the time window according to an embodiment of the present disclosure. In FIG. 4, the first reference point is the last slot before a drx-onDurationTimer or a drx-inactivityTimer expires (e.g. the end of the DRX On duration). The start of the time window is the (first) offset after the first reference point in this embodiment.

In some embodiments, the first reference point is associated with a system frame number (SFN) or a system frame.

In some embodiments, the first reference point may be one of:
a system frame or a slot or a subframe before the beginning of a slot where the UE would start the drx-onDurationTimer;
a system frame or a slot or a subframe after the last slot before the drx-onDurationTimer or the drx-inactivity Timer expires;
the end of the drx-onDurationTimer or the drx-inactivity Timer expires;
the first subframe of each a system frame;
SFN;
system frame;
the X-th subframe of every Y-th SFN, wherein X is an integer greater than or equal to 0 and less than 10 and Y is an integer greater than or equal to 0 and less than 513;
a beginning of a system frame;
an end of a system frame;
an end of a slot at where the on-duration timer for the next DRX cycle starts;
a slot or a subframe of a start of a jitter window;
a slot or a subframe of an end of a jitter window;
an ACK;
a PDSCH;
a slot or a subframe of a middle of a jitter window.

In an embodiment, the system frame is denoted/represented by an SFN.

In some embodiments, the first reference point is associated with a slot of a start of the jitter window. FIG. 5 shows a schematic diagram of the time window according to an embodiment of the present disclosure. As shown in FIG. 5, the first reference point is the slot of the start of the jitter window and the start of the time window is the (first/second) offset before the first reference point.

In some embodiments, the first reference point is an end location of a slot where the UE would start the drx-onDurationTimer.

In some embodiments, the first reference point is a slot of an end of the jitter window.

Note that jitter is an offset between a packet generation time and a time when a packet arrives at base station (e.g. gNB). The length of the jitter window denotes a range of the jitter. For example, the jitter may be within [−4 ms, 4 ms] and the length of the jitter window is 8 ms. In other words, the jitter window may be seen as a range of the packet may arrive at the gNB.

In some embodiments, the jitter window is where the UE monitors the PDCCH.

In some embodiments, the jitter window is where the UE monitors the PDCCH for a XR traffic.

In some embodiments, the jitter window is associated with an SPS (Semi-persistent scheduling)/CG (configured grant) configuration or an SPS/CG group.

In some embodiments, the first offset is associated with at least one of: a PDB, a jitter range, a protocol data unit (PDU) set, a quality indicator of a PDU set, traffic parameter(s).

In an embodiment, the traffic parameter(s) associated with the first offset includes at least one of: QoS (quality of service), a traffic periodicity, an FPS (frame per second), priority information.

In an embodiment, the first offset is same or smaller than half of the PDB.

In an embodiment, the first offset is a value associated with a PDB value.

In an embodiment, the first offset is a value associated with a traffic parameter.

In an embodiment, the first offset is a value associated with an FPS (value).

In an embodiment, the first offset is a value associated with a PDU set.

In an embodiment, the first offset is a value associated with a quality indicator of a PDU set. For example, the first offset is configured per quality indicator of the PDU set. As an alternative or in addition, one first offset is configured to be associated with one quality indicator of the PDU set.

In an embodiment, the first offset is a value associated with a length of jitter window.

In an embodiment, the first offset is a value associated with a traffic periodicity.

In an embodiment, the first offset is same or smaller than half of the traffic periodicity.

In an embodiment, the first offset is same or smaller than 1000/FPS.

In an embodiment, the first offset may have different candidate values corresponding to different QoS values. For example, the candidate values and/or the mapping between the candidate values and the QoS values may be predefined. In another embodiment, each QoS value is associated with a first offset.

In an embodiment, the first offset may have different candidate values for different priority information values. For example, the candidate value corresponding to the priority information value of a low priority is smaller than or equal to that corresponding to the priority information with a high priority. In another embodiment, each priority is associated with a first offset.

In an example, the end of the time window is determined by at least one of: the second reference point, the (second) offset, the minimum time gap, the window length, the jitter range, the jitter window, the number of monitor occasions.

In some embodiments, the second reference point may be/include at least one of:
the beginning of a slot where the UE would start the drx-onDurationTimer;
the last slot before a drx-onDurationTimer or a drx-inactivityTimer expires;
the end of a drx-onDurationTimer or a drx-inactivityTimer expires;
an SFN;
a system frame;
the slot of the start of the jitter window;
the end of the slot where the UE would start the drx-onDurationTimer;
the slot of the end of the jitter window.

In some embodiments, the end of the time window is determined by at least the second reference point and the second offset, wherein the second offset is a time duration between the second reference point and the end of the time window.

In some embodiments, UE continues monitoring the first signaling until UE detects a first signaling indicates start on-duration timer.

In some embodiments, the second offset is the minimum time gap and the second reference point is the beginning of the slot where the UE would start the drx-onDurationTimer.

In some embodiments, the end of the time window is determined by at least the first reference point, the first offset and the window length. For example, the first reference point and/or the first offset is used to determine the start of the time window and the time window ends at the window length after the determined start.

In some embodiments, the end of the time window and/or the window length is associated with the jitter range. For example, the window length is determined according to the jitter range. IN an embodiment, the window length is equal to the jitter range. In another embodiment, the window length is smaller than the jitter range.

In some embodiments, the second offset is associated with at least one of: a UE capability, a predefined value, a SCS (sub-carrier spacing), a high layer signaling. For example, predefined values are predefined to be associated with different SCS and different UE capability. Second offset is configured by a high layer signaling, and the value of second offset configured should be not smaller than the predefined value.

In some embodiments, the window length is associated with at least one of: the PDB, the jitter range, the traffic parameter, the PDU set, or the quality indicator of a PDU set.

In an embodiment, the traffic parameter(s) associated with the window length includes at least one of: QoS (quality of service), the traffic periodicity, an FPS (frame per second), or the priority information.

In an embodiment, the window length is same or larger than half of the PDB.

In an embodiment, the window length is same or larger than half of the traffic periodicity.

In an embodiment, the window length is same or larger than 1000/FPS.

In an embodiment, the window length may have the same or different candidate values corresponding to different QoS values. For example, the candidate values and/or the mapping between the candidate values and the QoS values may be predefined.

In an embodiment, the window length may have the same or different candidate values for different priority information values. For example, the candidate value corresponding to the priority information value of a low priority is smaller than or equal to that corresponding to the priority information with a high priority.

In some embodiments, the UE stops monitoring the first signaling if the UE has monitored a certain number of monitor occasions for the first signaling.

In some embodiments, the UE stops monitoring the first signaling if a timer expires. In these embodiments, the timer may be triggered at the start of the time window.

In some embodiments, the UE monitors a certain number of (a part of) slots in each monitor occasion, a certain number of monitor occasions or a certain number of cycles of the first signaling from the start of the time window.

In some embodiments, the UE monitors a certain number of (e.g. a part of) slots in each monitor occasion' slots, a certain number of monitor occasions or a certain number of cycles for a search space set of the first signaling from the beginning the time window.

In an example, a monitoring pattern of the first signaling may be configured or indicated by a signaling. The monitoring pattern may include at least one of: a monitoring cycle, a pattern, or a bitmap. For example, the signaling configuring/indicating the monitoring pattern may a DCI or a MAC CE signaling.

In some embodiments, the monitoring pattern indicates that the UE monitors the first signaling only in odd slots (i.e. the slots having odd indexes).

In some embodiments, the monitoring pattern includes a monitoring cycle. The unit of monitoring cycle is subframe or millisecond. The UE monitors the first signaling if (SFN*10+subframe number) mod (monitoring cycle)=I, where I is an integer greater than or equal to 0 and less than the monitoring cycle.

In some embodiments, the monitoring pattern includes a monitoring cycle. In these embodiments, the unit of the monitoring cycle is slot. The UE monitors the first signaling if (numberOfSlotsPerFrame×SFN+slot number/index in the frame) mod (monitoring cycle)=I, where I is an integer greater than or equal to 0 and less than the monitoring cycle.

In the present disclosure, the term “mod” represents the modulo/mod function. For example, a result of a number NUM_1 mod another number NUM_2 is the reminder of the division of NUM_1 by NUM_2.

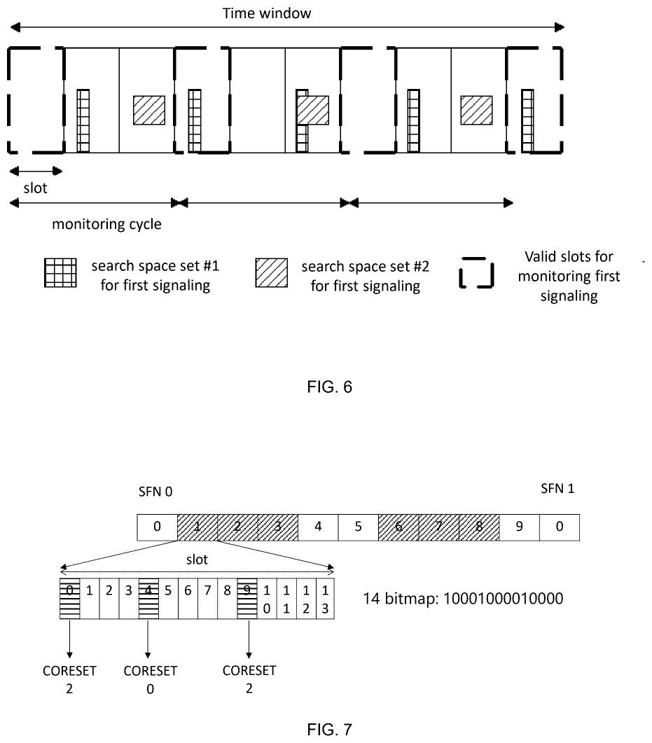

FIG. 6 shows a schematic diagram of the monitoring pattern according to an embodiment of the present disclosure. In this embodiment, the monitoring pattern includes the monitoring cycle. As shown in FIG. 6, the monitoring cycle indicates certain valid slots and the UE monitors the first signaling only in the indicated valid slots if a search space set for the first signaling is configured in these slots during the time window.

In some embodiments, the monitoring pattern includes the bitmap. The bitmap length may be equal to or less than the time window. In the bitmap, one bit is corresponding to one or more slots or milliseconds. For example, bit ‘1’ means valid and ‘0’ means invalid. Based on the bitmap, the UE monitors the first signaling only in the valid slots if the search space set for first signaling is configured in these slots during the time window.

In an embodiment, the length/duration of the time window is 10 slots and the bitmap comprises 5 bits ‘00111’. In this embodiment, the bitmap may be repeated during the time window. That is the UE monitors the first signaling in the 3rd, 4th, 5th, 8th, 9th and 10th slots in the time window. As an alternative, one bit in the bitmap indicates 2 slots. In other words, the UE monitors the first signaling in the 5th, 6th, 7th, 8th, 9th, 10th slots in the time window.

In an example, the first signaling indicates at least one of:
whether to start the drx-onDurationTimer,
when to start drx-onDurationTimer,
a time duration,
a temporary offset,
a change offset,
a search space set group index.

The information/parameter(s) indicated by the first signaling is discussed in the following.

In some embodiments, 1 bit in the first signaling is used to indicate whether to start drx-onDurationTimer after a time duration. For example, the bit ‘1’ denotes starting the drx-onDurationTimer after a time duration. In addition, the bit ‘0’ represents reserved or continuing to monitor the first signaling or not starting drx-onDurationTimer after a time duration

In some embodiments, the first signaling indicates a temporary offset. The temporary offset is used to determine when to start the drx-onDurationTimer. For example, the temporary offset=0 indicates continuing to monitor the first signaling or not starting the drx-onDurationTimer after a time duration. In an embodiment, the temporary offset=A, where A is a positive integer, indicates starting the drx-onDurationTimer after A slots/ms.

In some embodiments, the first signaling indicates a time duration. The time duration is used to determine/indicate when to start the drx-onDurationTimer. For example, the time duration=0 indicates continuing to monitor the first signaling or not starting the drx-onDurationTimer. In an embodiment, the time duration=A, where A is a positive integer, indicates starting the drx-onDurationTimer after A slots/ms. In an embodiment, an RRC signaling configures one or more candidate values of the time duration. The first signaling indicates one of the candidate values. For example, the RRC signaling configures a list of time durations or a list of candidate values for the time duration. In addition, a bit X, indicated by (e.g. comprised in) the first signaling, indicates the (X+1)-th time duration or candidate value in the list. In some embodiments, the time duration may be also used for determining the start position of the on duration timer when a predefined condition is satisfied.

In some embodiments, the first signaling indicates a changing offset for the drx-startoffset. The changing offset for drx-startoffset is used to change the drx-startoffset. For example, the changing offset=A1 (where A1 is an integer greater than or equal to 0) indicates that the drx-startoffset is adjusted/changed by the changing offset (e.g. drx-startoffset=drx-startoffset+changing offset.

Note that the temporary offset or the time duration may be configured to determine the time of starting the drx-onDurationTimer for the next long DRX cycle (after receiving the first signaling). The changing offset may be configured to change the drx-startoffset for all subsequent long DRX cycles (after receiving the first signaling). That is the changing offset may influence the time of starting the drx-onDurationTimer in all subsequent long DRX cycles.

In some embodiments, the first signaling indicates the search space set group index. The UE monitors the PDCCH according to the indicated search space set group index when the drx-onDurationTimer is started/running.

In an example, the first signaling may be the DCI or a sequence based signaling.

In some embodiments of the first signaling being the DCI, the first signaling may be associated with at least one of the following configuration parameters: a search space set, a new RNTI, a start position of indication information of the first signaling, a DCI size of the first signaling, an enable signaling, a QCL (Quasi Co Location) state, or a TCI (Transmission Configuration Indication) state. These configuration parameters may be named first signaling parameters.

In some embodiments, the first signaling parameters or configuration parameters are configured by a high layer signaling.

In some embodiments, the first signaling parameters may comprise the search space set and/or a CORESET (Control resource set). The search space set and/or the CORESET is used to determine the monitoring occasion of the DCI. In the following, the search space set configuration method for the first signaling is illustrated.

In some embodiments, the configuration of one search space includes at least one of:
searchSpaceId: Identity of the search space.
controlResourceSetId: CORESET applicable for this search space.
duration: The number of consecutive slots that the search space lasts in every occasion.
monitoringSlotPeriodicityAndOffset: Slots for the PDCCH monitoring configured by a periodicity and an offset.
monitoringSymbolsWithinSlot: The first symbol(s) for the PDCCH monitoring in the slots configured for the PDCCH monitoring.
nrofCandidates: The number of PDCCH candidates per aggregation level.

In some embodiments, the configuration of search space set used for the first signaling have certain restrictions, so as to reduce the possibility of blind decoding and save power.

In an embodiment, the number of the search space sets used for the first signaling is not larger than a first threshold A, where the first threshold A is an integer greater than 0 and less than 3. In another embodiment, the first threshold, A is an integer greater than 0 and less than 4.

In an embodiment, the duration of the search space set used for the first signaling is not larger than a second threshold B, where the second threshold B is an integer greater than 0 and less than 30. Note that the second threshold B may be associated with an SCS. For example, the second threshold B associated with a large SCS is greater than or equal to the second threshold B associated with a small SCS. In another embodiment, the second threshold B is an integer greater than 0 and less than 120.

In an embodiment, the periodicity of the search space set used for the first signaling is not less than a third threshold C which is an integer greater than 1. The third threshold C may be associated with the SCS. For example, the third threshold C associated with a large SCS is greater than or equal to the third threshold C associated with a small SCS.

In an embodiment, the number of aggregation levels of the search space set used for the first signaling is not larger than a fourth threshold D which is an integer greater than 0 and less than 3. As an alternative, the fourth threshold D is an integer greater than 0 and less than 5.

In an embodiment, the maximum of aggregation level of the search space set used for the first signaling is a fifth threshold E. For example, the fifth threshold E is an integer not greater than 8. In another example, the fifth threshold E is 4. In another example, the fifth threshold E is 2.

In an embodiment, the number of PDCCH candidates per aggregation level of the search space set used for the first signaling is not larger than a sixth threshold F. The sixth threshold F may remain the same or be changed for different aggregation levels. For example, the sixth threshold F associated with a lower aggregation level may be larger than or equal to the sixth threshold F associated with a higher aggregation level. As an alternative, the sixth threshold F is an integer not greater than 2. In another example, the sixth threshold F is an integer not greater than 4.

In an embodiment, the total number of PDCCH candidates of the search space set used for the first signaling is not larger than a seventh threshold G. For example, the seventh threshold G is an integer greater than 0 and less than 20. In another example, the seventh threshold G is an integer not greater than 24.

In an embodiment, a number of the monitoring occasion in one slot of the search space set used for the first signaling is not larger than an eighth threshold H. The eighth threshold H may be an integer greater than 0 and less than 3. In another embodiment, the eighth threshold H is an integer not greater than 3.

In some embodiments, the DCI format may be scrambled by a new RNTI.

In an embodiment, the new RNTI is used for (scrambling) the DCI which indicates whether an XR traffic will be transmitted.

In an embodiment, the new RNTI is used for (scrambling) the DCI which indicates whether to start the drx-onDurationTimer after a time duration. In this embodiment, the time duration may be a predefined value or be indicated by the first signaling or by another high layer signaling.

In an embodiment, the new RNTI is used for the DCI indicating a time duration or a temporary offset or a change offset.

In an embodiment of the time duration being the predefined value, the predefined value is associated with the SCS. For example, the predefined value associated with a large SCS is larger than or equal to the predefined value associated with a small SCS.

In an embodiment of the time duration being the predefined value, the predefined value is the minimum time gap or the second offset.

In an embodiment of the time duration being the predefined value, the predefined value is 0.

In an embodiment the time duration being indicated by the first signaling or configured by another high layer signaling, one SCS may be associated/configured with one time duration. For example, the time duration associated with a large SCS may be configured to be larger than or equal to the time duration associated with a small SCS.

In an embodiment the time duration being configured by the first signaling or another high layer signaling, the first signaling or the high layer signaling may configure a list of candidate values for the time duration. In this embodiment, the corresponding DCI indicates one of the candidate values as the time duration.

In an embodiment, the time duration is associated with a predefined gap. In this embodiment, the UE does not expect to be indicated or configured with a time duration value which is smaller than the predefined gap. The predefined gap may be the same or different for different SCSs. For example, the predefined gap corresponding to a smaller SCS is not greater than the predefined gap corresponding to a greater SCS. In an embodiment, the predefined gap has different values for different UE capabilities. In an embodiment, the predefined gap is the minimum time gap.

In an embodiment, the new RNTI is used for (scrambling) the DCI which indicates whether to change the drx-startoffset.

In an embodiment, the new RNTI is used for (scrambling) the DCI which indicates whether to monitor the DCI in next/following monitoring occasion.

In some embodiments, the size of the first signaling (e.g. DCI size) is not larger than a ninth threshold J. The ninth threshold J may be an integer greater than 0 and less than 30. For example, the ninth threshold J is 24. As an alternative, the ninth threshold J is 18. As another alternative, the ninth threshold J is 12.

In an embodiment, the size of the first signaling may be different from the DCI scrambled with an RNTI other than the C-RNTI.

In an embodiment, if a search space set used for the first signaling is configured in a serving cell, the UE is expected to monitor PDCCH candidates for up to 5 sizes of DCI formats that include up to 3 sizes of DCI formats with the CRC scrambled by the C-RNTI in the serving cell

In an embodiment, when the UE is monitoring the first signaling (in the time window), the UE is expected to monitor PDCCH candidates for up to 5 sizes of DCI formats that include up to 3 sizes of DCI formats with the CRC scrambled by the C-RNTI in the serving cell.

In an embodiment, the UE is expected to monitor PDCCH candidates for up to 5 sizes of DCI formats if one of is a size of first signaling when monitoring the first signaling (in the time window).

In some embodiments, a high layer signaling indicates a starting position of indication information in the first signaling (e.g., DCI).

In some embodiments, a first signaling comprises one or more blocks. Each block includes one or more bits. Each block is associated with one UE or a group of UEs. The one or more bits in one block includes indication information for the associated UE or the associated group of UEs. In an embodiment, the group of UEs is configured by a high layer signaling.

In an embodiment, the first signaling is the DCI format 2_6 with the new RNTI. The field(s) in the DCI format 2_6 is re-purposed to indicate the indication information.

In some embodiments, if the number of monitor occasions associated with a search space set configuration is larger than one, different monitor occasions or slots in one duration may be associated with different or the same CORESET index.

In an embodiment, the number of monitor occasions may be one of:
the number of the monitor symbol groups of the first signaling associated with a search space set configuration in one slot;
the number of monitor symbol groups of the first signaling associated with a search space set configuration in one duration;
the number of monitor symbol groups or monitor slots associated with a search space set configuration in the time window;
the number of slots associated with a search space set configuration in one duration,
the number of the monitor symbol groups of the first signaling in one slot;
the number of monitor symbol groups of the first signaling in one duration;
the number of monitor symbol groups or monitor slots in the time window;
the number of slots in one duration.

In an embodiment, one monitor occasion represents the monitor occasion of the first signaling in one slot or a slot in one duration.

In an embodiment, one monitor occasion represents the monitor occasion of the first signaling associated with a search space set in the time window.

In an embodiment, the number of the monitor symbol groups of the first signaling in one slot is the number of values ‘1’ configured in monitoringSymbolsWithinSlot.

In an embodiment, the “monitor symbols group” is the equal to “monitor occasion”.

In an embodiment, one monitor occasion is associated with one CORESET. The relation between the monitor occasions and the CORESETs may indicated by an RRC signaling.

In an embodiment, one monitor occasion is associated with one CORESET. In this embodiment, the relation between the monitor occasions and the CORESETs may be derived.

In some embodiments, the RRC signaling configures a CORESET list. The number of CORESETs in the CORESET list is A and the number of monitor occasions in one time interval is B.

In an embodiment of A=B, the first monitor occasion is associated with the first CORESET in the CORESET list, the second monitor occasion is associated with the second CORESET in the CORESET list, and so on.

In an embodiment of A<B, the i-th monitor occasion is associated with mod(i,A)-th CORESET in the CORESET list. That is, the first monitor occasion is associated with the first CORESET, . . . , the A-th monitor occasion is associated with the A-th CORESET in the CORESET list, the (A+1)-th monitor occasion is associated with the first CORESET in the CORESET list, the (A+2)-th monitor occasion is associated with the second CORESET in the CORESET list, and so on.

In an embodiment of A<B, the monitor occasions are divided into A groups. Each group is associated with one CORESET in the CORESET list. For example, the number of monitor occasions in some groups may be equal to [round down (B/A)]. The number of monitor occasions in last group is determined by:

B−(A−1)*[round down(B/A)].

Note that [round down (B/A)] represents rounding down a quotient of a division of B by A to an integer which is the maximum integer smaller than the quotient.

The monitor occasions are divided into groups in order. That is the first round down (B/A) monitor occasions are in the first group and is associated with the first CORESET in the CORESET list, and so on.

Note that, the above mapping method is for the time interval being one search space set cycle (i.e. duration of the search space set) or one slot or a time window. For another time interval, the mapping function is same.

The time interval may also be one or more consecutive search space set cycles (i.e. durations of the search space set) or one or more consecutive slots. The monitor occasion may also be change to one or more consecutive monitor occasions or one or more consecutive slots.

FIG. 7 shows a schematic diagram of the monitor occasion of the first signaling according to an embodiment of the present disclosure. In this embodiment, the first signaling parameters are configured as:
monitoringSlotPeriodicityAndOffset: periodicity=4 slots, offset=1 slot;
Duration: 2 slots
monitoringSymbolsWithinSlot: 14 bitmap 1000 1000010000
controlResourceSetId: 2, 0

As shown in FIG. 7, the number of monitor occasions of the first signaling in one slot is three (located in symbols 0, 4, and 9). The first monitor occasions in the slot are associated with the CORESETs which is the first CORESET configured in the search space set. The second monitor occasion in the same slot are associated with second CORESET which is configured in the search space set, the third monitor occasion in the same slot are associated with first CORESET. The order is according to the sequence from the low index to high index.

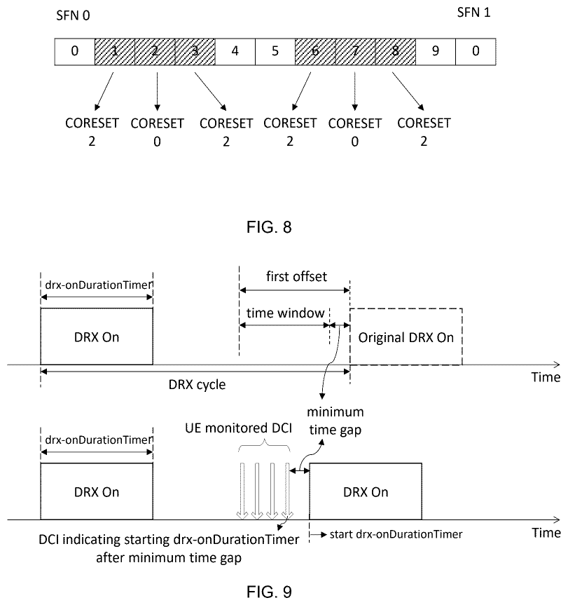

FIG. 8 shows a schematic diagram of the monitor occasion of the first signaling according to an embodiment of the present disclosure. In this embodiment, the first signaling parameters are configured as:
monitoringSlotPeriodicityAndOffset: periodicity=4 slots, offset=1 slot;
Duration: 3 slots;
controlResourceSetId: 2.

In FIG. 8, the number of slots in one duration is three and the first monitor occasion associated with the CORESET 2 which is configured in the search space set. The next monitor occasion is associated with CORESET 0. The relation of the monitor occasions and CORESET is repeated for the other monitor occasion in order in one duration. In another words, the i-th monitor occasion in one duration is associated with the CORESET which is configured in the search space set if mod(i/2)=1; otherwise, the i-th monitor occasion in one duration is associated with CORESET 0. That is the monitor occasion with an odd index and the monitor occasion with an even index are associated with different CORESETs (in this embodiment, one is CORESET 0 and the other is CORESET which is configured in the search space set). In some embodiments, only one CORESET may be associated with a search space set. A default CORESET may be used for different monitor occasion. In this example, default CORESET is CORESET 0.

Note that, although only two CORESETs 0 and 2 are used in the embodiments shown in FIGS. 7 and 8, the number of CORESETs used for the monitor occasions of the first signaling may be greater than 2 in other embodiments. In some embodiments, the CORESETs used for the monitor occasions of the first signaling is configured by RRC signaling.

In an embodiment, the monitor occasion is associated with a CORESET represents that the CORESET is applicable for this monitor occasion is in the search space.

In an embodiment, the monitor occasion is associated with a CORESET means that the TCI state or the QCL of the monitor occasion uses the TCI state or the QCL of the CORESET.

In some embodiments, a CORESET list is configured in the search space set if the number of monitor occasions is more than one. In this embodiment, each monitor occasion may be associated with one CORESET in the CORESET list.

In an embodiment, the number of CORESETs in the CORESET list is the same as the number of monitor occasions. The mapping between the CORESET and the monitor occasion may be one to one mapping.

In an embodiment, the number of CORESETs in the CORESET list is smaller than the number of monitor occasions. In this embodiment, multiple monitor occasions may be mapped to one CORESET. For example, the number of CORESETs in the CORESET list is Num_A, the number of monitor occasions is Num_B and the i-th monitor occasion is mapped to (or associated with) j-th CORESET, where j=mod(i/Num_A). As an alternative, the monitor occasions may be divided into Num_A groups. The group(s) other than the last group includes function (Num_B/Num_A) monitor occasions and the last group includes Num_B−(Num_A−1)*function (Num_B/Num_A) monitor occasions. the monitor occasion in the i-th group are associated with the i-th CORESET in the list. The function may be a function of keeping the value or a round down function or round up function.

In some embodiments, if the number of monitor occasions is larger than one, different monitor occasions or slots in one duration may be associated with different or the same TCI state.

In an embodiment, one search space may be associated with a TCI state list. In this embodiment, one monitor occasion is associated with one TCI state in the TCI state list. In this embodiment, the mapping between the monitor occasions and the TCI states may be the same with that between the monitor occasions and the CORESETs.

In some embodiments, if the monitor occasion(s) of the first signaling in one slot is more than one, different monitor occasions may be associated with different or the same SSB (Synchronization Signal block).

In an embodiment, the mapping between the monitor occasions and the SSBs may be the same with that between the monitor occasions and the CORESETs.

In an embodiment, the monitor occasion is associated with an SSB means that a demodulation reference signal (DMRS) port of the monitor occasion is quasi co-located with the SSB.

In some embodiments, the first signaling is a sequence based signaling or a reference signal.

In an example, the UE monitors the first signaling during the time period/window. Note that, the UE may not monitor the first signaling within the active time of the DRX. That is, if the time window is within the active time, the UE does not monitor the first signaling in the time window.

In an embodiment of a part of the time window being within the active time, the UE monitors the first signaling in the part which is in the time window and outside of the active time. As an alternative, the UE does not monitor the first signaling in the time window if the time window at least partly overlaps the active time. As another alternative, the UE monitors the first signaling in the time window even if a part of the time window overlaps the active time.

In some embodiments, the UE monitors the first signaling if at least one of the following occurs:
the UE is outside of the active time;
the UE is configured with a search space for the first signaling;
the UE receives an enable/activation signaling;
the UE is within the time period/window;
the UE receives the first signaling indicating continuing to monitor the first signaling;
the UE does not receive the first signaling indicating starting the drx-onDurationTimer after a time duration.

In an embodiment, the enable/activation signaling may be a MAC CE or DCI or an RRC signaling.

In an embodiment, the enable/activation signaling indicates enabling or starting monitoring of the first signaling.

In some embodiments, the UE stops monitoring the first signaling if at least one of the following occurs:
the UE is in the active time;
the UE is outside the time period (window);
the UE receives the first signaling indicates starting drx-onDurationTimer after a time duration.

In an example, the predefined condition is associated with at least one of: a timer, a time window, a DCI format, an RNTI, an enable signaling, a UE capability signaling.

In some embodiments, the predefined condition is satisfied if at least one of following is occurred.
a) The UE does not detect a first signaling indicates starting the drx-onDurationTimer after a time duration during the time window.
b) The UE receives an enable signaling.

In an embodiment, the enable signaling indicates enabling changing the drx-startoffset. In an embodiment, the enable signaling indicates enabling monitoring the first signaling.
c) The UE reports a UE capability signaling.

In an embodiment, the capability signaling indicates that the UE supports monitoring the first signaling.
d) A timer expires.

In an embodiment, the timer is triggered/re-triggered if a scheduling DCI is received.

In an embodiment, the timer is triggered/re-triggered if a scheduling DCI is received for the XR service/traffic.

In an embodiment, the timer is triggered/re-triggered if the first signaling is received.

In an embodiment, the timer is triggered/re-triggered if a first kind of DCI format is received. For example, the first kind of DCI format may include at least one of: a DCI used for the XR service/traffic, a DCI format 0_1, a DCI format 1_1, a DCI format 0_2, a DCI format 1_2, a DCI format 2_6.

In an embodiment, the timer is activated the first slot where the UE is outside the active time.

In an embodiment, the timer is activated at the first slot after the drx-onDurationTimer or the drx-inactivityTimer or a drx-retransmission Timer expires.
e) A first kind of DCI format is received.

For example, the first kind of DCI format may include at least one of: a DCI used for the XR service/traffic, a DCI format 0_1, a DCI format 1_1, a DCI format 0_2, a DCI format 1_2, a DCI format 2_6.
f) DCI scrambled with a first kind of RNTI is received.

For example, the first kind of RNTI may include at least one of: a new RNTI (e.g., for XR service/traffic), a PS-RNTI, s C-RNTI, a CS-RNTI, an MCS-C-RNTI.

In an example, the position of the start of DRX on duration timer is determined based on the first signaling and/or the predefined condition. For example, UE determines the position of the start of DRX on duration timer if a predefined condition is satisfied and receives a first signaling.

In some embodiments, the predefined condition is that the UE does not detect the first signaling which indicates starting the drx-onDurationTimer after the time duration during the time window. If the UE detects the first signaling which indicates starting the drx-onDurationTimer after the time duration during the time window, the position of the start of DRX on duration timer is indicated by the first signaling or the position of the start of DRX on duration timer is after the time duration after (the time of receiving) the first signaling. Otherwise, if the predefined condition is satisfied, the position of the start of DRX on duration timer is still be at an original position.

In some embodiments, the predefined condition is that the UE receives the enable signaling. If UE detects the first signaling which indicates starting the drx-onDurationTimer after the time duration during the time window and the predefined condition is satisfied, the position of the start of DRX on duration timer is after the time duration after (the time of receiving) the first signaling. Otherwise, the position of the start of DRX on duration timer is the original position.

In an example, the position of the start of DRX on duration timer is determined by the predefined condition. For example, if the predefined condition is satisfied, the position of the start of DRX on duration timer is after the time duration after the predefined condition is satisfied.

In an example, the position of the start of DRX on duration timer is determined by the first signaling. For example, if the UE detects the first signaling that indicates starting the drx-onDurationTimer after a time duration during the time window, the position of the start of DRX on duration timer is indicated by the first signaling. That is the position of the start of DRX on duration timer is after the time duration after (the time of receiving) the first signaling.

In an example, if the UE does not detect a first signaling indicates start drx-onDurationTimer after the time duration during the time window, one of the following will occur.
A) the UE starts the drx-onDurationTimer for the next long DRX cycle.

In some embodiments, the UE monitors the PDCCH according to a default SSSG (search space set group) if the SSSG is configured before receiving the DCI during the active time. For example, the default SSSG may be predefined or configured by an RRC signaling. As an alternative, the default SSSG may be the SSSG with the highest index or the SSSG with the lowest index.

In some embodiments, the UE monitors only DL DCI before receiving the DCI during the active time.
B) The UE starts the drx-on Duration Timer after a time duration for the next long DRX cycle.

In some embodiments, the UE monitors the PDCCH according to a default SSSG if SSSG is configured before receiving the DCI during the active time. For example, the default SSSG may be predefined or configured by an RRC signaling. As an alternative, the default SSSG may be the SSSG with the highest index or the SSSG with the lowest index.

In some embodiments, the UE monitors only DL DCI before receiving the DCI during the active time.
C) the UE does not start the drx-onDurationTimer for the next long DRX cycle;
D) the UE determines whether or not to start the drx-onDurationTimer for the next long DRX cycle according to a high layer signaling.

In some embodiments, the high layer signaling indicates whether or not start the drx-onDurationTimer for the next long DRX cycle.

In some embodiments, if the high layer signaling is not configured, the UE performs a default behavior. The default behavior may be predefined.

In an example, if the UE is not able to monitor the first signaling during the time window (e.g., because the time window is in the active time, there is no available monitor occasion for first signaling), one of the following will occur.
A) the UE starts the drx-onDurationTimer for the next long DRX cycle at original position.
B) the UE starts the drx-onDurationTimer after a time duration for the next long DRX cycle.
C) the UE determines whether to start the drx-onDurationTimer for the next long DRX cycle according to a high layer signaling.

In some embodiments, the high layer signaling indicates whether or not start the drx-onDurationTimer for the next long DRX cycle.

In some embodiments, if the high layer signaling is not configured, the UE performs a default behavior. The default behavior may be predefined.

In an example, the UE does not expect to configure DCP (DCI with CRC scrambled by PS-RNTI) and the first signaling parameters simultaneously.

In an example, the UE is configured with the DCP and the first signaling parameters simultaneously. In this example, the first signaling parameters includes an enable signaling. The enable signaling indicates whether the UE monitors the first signaling or whether to enable the first signaling. If the enable signaling indicates that the UE monitors the first signaling or the enable signaling indicates to enable the first signaling, the UE monitors the first signaling and does not monitor the DCP; otherwise, the UE monitors DCP and does not monitor the first signaling.

In an example, the DCP and first signaling are associated with different CORESETs.

In an example, the UE monitors the first signaling in PCell (Primary cell), a PSCell (Primary secondary cell) or a ssCell (SCell used for scheduling PCell/PSCell).

In an example, the UE may monitor the first signaling in each active serving cell.

In some embodiments, the UE does not expect to receive inconsistent indication information simultaneously. For example, the UE does not expect to receive inconsistent indication information in one slot, in one monitor occasion, or in one millisecond.

In an example, indication information indicated in the first signaling is used for a group of UEs. The group to which the UE belongs is configured by a high layer signaling.

FIG. 9 shows a schematic diagram of the time window according to an embodiment of the present disclosure. In FIG. 9, the first signaling is the DCI. In addition, the time window is determined according to the first reference point, the first offset and the minimum time gap. In this embodiment, the first reference point is predefined as the beginning of a slot where the UE would start the drx-onDurationTimer. The first offset is configured by an RRC signaling. The first offset indicates the time duration between the start position of the time window and the first reference point. The end of the time duration is the slot or millisecond minimum time gap before the first reference point. The DCI indicates whether or not start the drx-onDurationTimer after a time duration for the next long DRX cycle. The time duration is equal to the minimum time gap. After UE receives the DCI which indicates starting the drx-onDurationTimer after the minimum time gap, the UE stops monitoring the first signaling (i.e. DCI) and starts the drx-onDurationTimer after the minimum time gap. If the UE does not detect the DCI that indicates starting the drx-onDurationTimer after the minimum time gap during the time window, the UE starts the drx-onDurationTimer at original position of DRX On duration for the next long DRX cycle.

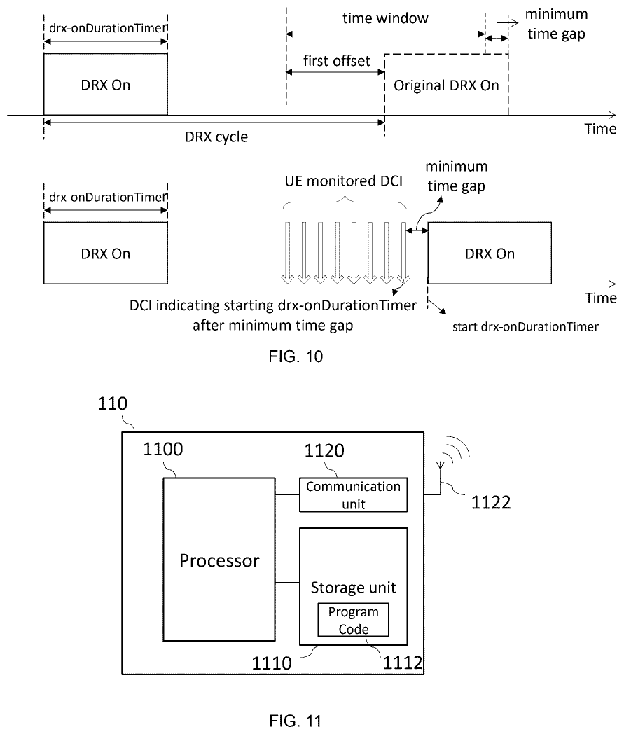

FIG. 10 shows a schematic diagram of the time window according to an embodiment of the present disclosure. In FIG. 10, the first signaling is the DCI and the time window is determined according to the first reference point, the first offset, the second reference point, and the minimum time gap. In this embodiment, the first reference point is predefined as the beginning of a slot where the UE would start the drx-onDurationTimer. The first offset is configured by an RRC signaling and is configured to indicate the time duration between the start position of the time window and the first reference point. The second reference point is (predefined as) the end of the drx-onDurationTimer of the next long DRX cycle. Note that the end of the time window is a slot, a millisecond minimum time gap before the second reference point. The DCI indicates whether to start the drx-onDurationTimer after a time duration, for the next long DRX cycle. The time duration is equal to the minimum time gap. After the UE receives the DCI which indicates starting the drx-onDurationTimer after the minimum time gap, the UE stops monitor the first signaling (i.e. DCI) and starts the drx-onDurationTimer after the minimum time gap. If, during the time window, the UE does not detect the DCI indicating starting the drx-onDurationTimer after the minimum time gap, the UE does not start the drx-onDurationTimer at the original position of DRX On duration for the next long DRX cycle.

FIG. 11 relates to a schematic diagram of a wireless terminal 110 according to an embodiment of the present disclosure. The wireless terminal 110 may be a user equipment (UE), a mobile phone, a laptop, a tablet computer, an electronic book, a Head-Mounted Display, a glasses with standalone capability or a portable computer system and is not limited herein. The wireless terminal 110 may include a processor 1100 such as a microprocessor or Application Specific Integrated Circuit (ASIC), a storage unit 1110 and a communication unit 1120. The storage unit 1110 may be any data storage device that stores a program code 1112, which is accessed and executed by the processor 1100. Embodiments of the storage unit 1110 include but are not limited to a subscriber identity module (SIM), read-only memory (ROM), flash memory, random-access memory (RAM), hard-disk, and optical data storage device. The communication unit 1120 may a transceiver and is used to transmit and receive signals (e.g. messages or packets) according to processing results of the processor 1100. In an embodiment, the communication unit 1120 transmits and receives the signals via at least one antenna 1122 shown in FIG. 11.

In an embodiment, the storage unit 1110 and the program code 1112 may be omitted and the processor 1100 may include a storage unit with stored program code.

The processor 1100 may implement any one of the steps in exemplified embodiments on the wireless terminal 110, e.g., by executing the program code 1112.

The communication unit 1120 may be a transceiver. The communication unit 1120 may as an alternative or in addition be combining a transmitting unit and a receiving unit configured to transmit and to receive, respectively, signals to and from a wireless network node (e.g. a base station).

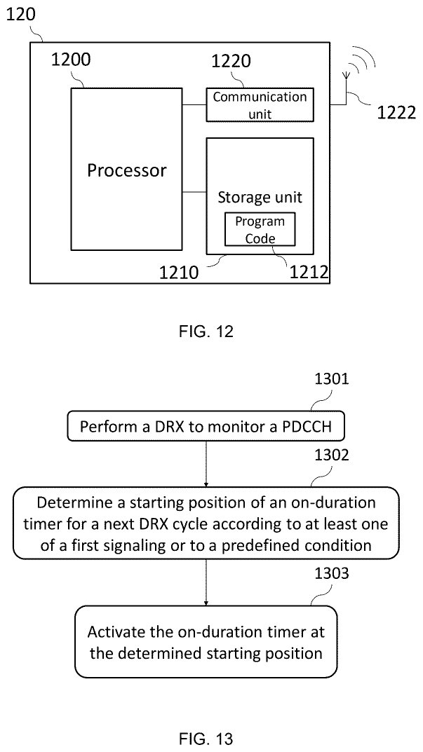

FIG. 12 relates to a schematic diagram of a wireless network node 120 according to an embodiment of the present disclosure. The wireless network node 120 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 120 may comprise (perform) at least one network function such as an access and mobility management function (AMF), a session management function (SMF), a user place function (UPF), a policy control function (PCF), an application function (AF), etc. The wireless network node 120 may include a processor 1200 such as a microprocessor or ASIC, a storage unit 1210 and a communication unit 1220. The storage unit 1210 may be any data storage device that stores a program code 1212, which is accessed and executed by the processor 1200. Examples of the storage unit 1210 include but are not limited to a SIM, ROM, flash memory, RAM, hard-disk, and optical data storage device. The communication unit 1220 may be a transceiver and is used to transmit and receive signals (e.g. messages or packets) according to processing results of the processor 1200. In an example, the communication unit 1220 transmits and receives the signals via at least one antenna 1222 shown in FIG. 12.

In an embodiment, the storage unit 1210 and the program code 1212 may be omitted. The processor 1200 may include a storage unit with stored program code.

The processor 1200 may implement any steps described in exemplified embodiments on the wireless network node 120, e.g., via executing the program code 1212.

The communication unit 1220 may be a transceiver. The communication unit 1220 may as an alternative or in addition be combining a transmitting unit and a receiving unit configured to transmit and to receive, respectively, signals to and from a wireless terminal (e.g. a user equipment or another wireless network node).

FIG. 13 shows a schematic diagram of a method according to an embodiment of the present disclosure. The method shown in FIG. 13 may be used in a wireless terminal (e.g. UE) and comprises the following steps.

Step 1301: Perform a DRX to monitor a PDCCH.

Step 1302: Determine a starting position of an on-duration timer for a next DRX cycle according to at least one of a first signaling or to a predefined condition.

Step 1303: Activate the on-duration timer at the determined starting position.

In the embodiment shown in FIG. 13, the wireless terminal performs the DRX to monitor the PDCCH. When performing the DRX, the UE determines a starting position of an on-duration timer for a next DRX cycle according to at least one of a first signaling or to predefined condition(s). In this embodiment, the first signaling is monitored in a time period. That is the UE may monitor the first signaling in the time period and/or determine whether the predefined condition(s) is satisfied, to determine the starting position of the on-duration timer. The UE activates the on-duration timer at the determined starting position. That is, the UE enters the DRX On state at the determined starting position, e.g., to monitor the PDCCH.

In an embodiment, the time period is determined by a monitoring period indicating a cycle of the first signaling.

In an embodiment, the time period is determined by at least one of a first reference point, a first offset, a second reference point, a second offset, a window length, a timer, a jitter window, a jitter value, a PDB, a traffic information, a minimum time gap, or a monitoring pattern.

In an embodiment, the start of the time period is determined based on the first reference point and the first offset. In this embodiment, the first offset indicates a time duration between the starting point of the time period and the first reference point.

In an embodiment, the first reference point may be one of a beginning of a slot or a subframe or a millisecond at where the on-duration timer for the next DRX cycle starts, a last slot where the on-duration timer or an inactivity timer or a retransmission timer of the DRX expires, a system frame where the beginning of the slot at where the on-duration timer for the next DRX cycle starts, a system frame where a last slot of the on-duration timer or an inactivity timer of the DRX expires, X-th subframe of every Y-th system frame, where X is an integer greater than or equal to 0 and smaller than 10 and Y is an integer greater than or equal to 0 and smaller than 513, a system frame, a beginning of a system frame, an end of a system frame, an end of a slot at where the on-duration timer for the next DRX cycle starts, a slot or a subframe of a start of a jitter window, a slot or a subframe of an end of a jitter window, a slot or a subframe of a middle of a jitter window.

In an embodiment, the first offset is one of: a value smaller than or equal to half of the PDB, a value associated with a PDB value, a value associated with a traffic parameter in the traffic information, a value associated with a frames per second value, a value associated with a length of jitter window, a value associated with a PDU set, a value associated with a quality indicator of PDU set, a value associated with a quality of service parameter, a value associated with a traffic periodicity in the traffic information, a value smaller than or equal to half of a traffic periodicity comprised in the traffic information, a value smaller than or equal to a quotient of a division of 1000 by an FPS parameter comprised in the traffic information.

In an embodiment, the first offset has different values for different values of a quality of service parameter or a priority parameter comprised in the traffic information.

In an embodiment, an end of the time period is determined based on at least one of a second reference point, a second offset, a minimum time gap, a window length, a jitter range, a jitter window, or a number of monitor occasions of the first signaling.

In an embodiment, the second reference point comprises/is at least one of: a beginning of a slot or a subframe or a millisecond where the on-duration timer for the next DRX cycle starts, a last slot where the on-duration timer or an inactivity timer or a retransmission timer of the DRX expires, a system frame where a beginning of the slot at where the on-duration timer for the next DRX cycle starts; a system frame after a last slot before the on-duration timer or an inactivity timer of the DRX expires, X-th subframe of every Y-th system frame, where X is an integer greater than or equal to 0 and smaller than 10 and Y is an integer greater than or equal to 0 and smaller than 513, a system frame, a beginning of a system frame, an end of a system frame, an end of a slot at where the on-duration timer for the next DRX cycle starts, a slot or subframe of a start of the jitter window, a slot or subframe of a middle of the jitter window, a slot or subframe of an end of the jitter window.

In an embodiment, the end of the time period is determined by the second reference point and the second offset. In this embodiment, the second offset indicates a time duration between the second reference point and the end of the time period.

In an embodiment, the end of the time period is determined by the window length indicating a time duration from a start of the time period to the end of the time period.

In an embodiment, the window length is associated with at least one of: a PDB, a jitter range, a quality indicator of a PDU set, or traffic information.

In an embodiment, the wireless terminal stops monitoring the first signaling after monitoring a fixed number of monitoring occasions of the first signaling.

In an embodiment, a unit of the time period is a slot or a millisecond.

In an embodiment, the wireless terminal monitors the first signaling in the time period according to a monitoring pattern.

In an embodiment, the monitoring pattern indicates a monitoring cycle, wherein monitoring the first signaling in the time period according to the monitoring pattern comprises: monitoring the first signaling in a time-domain position if (SFN*10+subframe number) mod (monitoring cycle)=I, where SFN is a system frame number corresponding to the time-domain position, subframe number is a subframe index corresponding to the time-domain position, and I is an integer greater than or equal to 0 and smaller than the monitoring cycle.

In an embodiment, the monitoring pattern comprises a bitmap. Each bit in the bitmap indicate whether at least one time interval in the time period is valid for monitoring the first signaling. For example, the time interval in the time period may be slot or millisecond. Based on the monitoring pattern of this embodiment, the wireless terminal monitors the first signaling in the valid time interval(s).

In an embodiment, the first signaling is DCI, a sequence based signaling or a reference signal.

In an embodiment, the first signaling comprises indication information for at least one of: whether to start the on-duration timer, whether to start the on-duration timer after a time duration, a time duration associated with starting the on-duration timer based on the first signaling or in response to the predefined condition, a temporary offset used to determine when to start the on-duration timer, a change offset used to determine a start offset associated with the on-duration timer, when to start the on-duration timer, or a search space set group index.

In an embodiment, the time duration is a predefined value, indicated by the first signaling or configured by a high layer signaling.

In an embodiment, the time duration is associated with a sub-carrier spacing, is a minimum time gap, is a second offset used for determining (the end of) the time period or is 0.

In an embodiment, the high layer signaling configures a list of candidate values for the time duration.

In an embodiment, the first signaling is DCI and is associated with at least one configuration parameter comprising at least one of a search space set, an RNTI, a start position of the indication information of the first signaling, a DCI size of the first signaling, an enable signaling, a QCL or a TCI state.

In an embodiment, the at least one configuration parameter is configured by a high layer signaling.

In an embodiment, there is at least one limitation on the configuration parameter(s) of the search space set. The at least one limitation can be referred to the above embodiments related to the first threshold A, the second threshold B, the third threshold C, the fourth threshold D, the fifth threshold E, the sixth threshold F, the seventh threshold G and the eighth threshold H.

In an embodiment, the RNTI associated with the first signaling (i.e. DCI) is used for at least one of: DCI associated with traffics of an extended reality service, DCI associated with an extended reality service, DCI indicating whether there is a traffic of extended reality service for the next DRX long cycle, DCI indicating whether to start the on-duration timer, DCI indicating whether to start the on-duration timer after the time duration, DCI indicating a time duration, a temporary offset or a change offset, DCI indicating whether to change a start offset associated with the on-duration timer, DCI indicating whether to monitor the DCI in a subsequent monitoring occasion.

In an embodiment of the first signaling being configured, the number of sizes of DCI formats for PDCCH candidates in the serving cell is up to 5, and the number of sizes of DCI formats having a cyclic redundancy check scrambled by a cell radio network temporary identifier in the serving cell is up to 3.

In an embodiment, at least one of the starting position of the indication information in the first signaling and a DCI size of the first signaling is indicated by a high layer signaling. In this embodiment, one or more bits in a block in the first signaling indicates the indication information for one or more wireless terminals in a group.

In an embodiment, the first signaling is the DCI format 2_6 scrambled with the RNTI.

In an embodiment, different monitor occasions for the first signaling in a time interval are associated with a plurality of transmission relations (e.g. QCL, TCI states, CORESETs and/or SSBs).

In an embodiment, the time interval is/comprises at least one search space set cycle, at least one slot, or the time period.

In an embodiment, each monitor occasion comprises one or more consecutive slots, one or more consecutive symbols, or one or more consecutive search space set cycles.

In an embodiment, one or more consecutive monitor occasions are grouped as a monitor occasion group associated with the same transmission relation.

In an embodiment, each monitor occasion or each monitor occasion group is configured, by a high layer signaling, to be associated with one transmission relation.

In an embodiment, the transmission relation associated with each monitor occasion or each monitor occasion group is determined based on a transmission relation list configured in a search space set of the first signaling.

In an embodiment, the monitor occasions in one time interval are divided into X groups, wherein X is the number of transmission relations in the transmission relation list.

In an embodiment, a first monitor occasion in the time interval is associated with a first transmission relation of a search space set of the first signaling and the remaining monitor occasions in the time interval are associated with at least one second transmission relation different from the first transmission relation.

In an embodiment, the wireless terminal monitors the first signaling if at least one of the following conditions exists: the time period is outside of an active time of the DRX (i.e. DRX On duration/period), a search space is configured for the first signaling, receiving, from the wireless network, an enable signaling or an activation signaling monitoring the first signaling, outside of an active time of the DRX (i.e. DRX off period), within the time period, another first signaling indicating continuing to monitor the first signaling was received, or not receiving the first signaling which indicates starting the on-duration timer after a time duration.

In an embodiment, the wireless terminal starts the on-duration timer for the next DRX cycle after a time duration if there is no available monitor occasion of the first signaling for the next DRX cycle.

In an embodiment, the predefined condition comprises at least one of: not detecting the first signaling indicating starting the on-duration timer after a time duration during the time period, receiving an enable signaling for enabling changing a start offset of the on-duration timer, receiving an enable signaling for enabling monitoring the first signaling, reporting a capability signaling indicating a support of monitoring the first signaling, a timer expires, the timer expires and not receiving a traffic during the timer running, receiving a first kind of DCI format, wherein the first kind of DCI format includes at least one of: a DCI used for XR service traffic, a DCI format 0_1, a DCI format 1_1, a DCI format 0_2, a DCI format 1_2, or a DCI format 2_6, receiving DCI scrambled with a first kind of RNTI. In this embodiment, the first kind of RNTI includes at least one of: an RNTI used for DCI associated with traffics of an extended reality service, an RNTI used for DCI indicating whether to start the on-duration timer, an RNTI used for DCI indicating whether to start the on-duration timer after the time duration. an RNTI used for DCI indicating whether to change a start offset associated with the on-duration timer, an RNTI used for DCI indicating whether to monitor the DCI in a subsequent monitoring occasion, a PS-RNTI, a C-RNTI, a CS-RNTI or a MCS-C-RNTI. In this embodiment, the timer is triggered under one of the following conditions: if receiving scheduling DCI, if receiving scheduling DCI for XR service traffic, if receiving the first signaling, if receiving a first kind of DCI format, at a first slot outside of an active time of the DRX, or at a first slot after the on-duration timer or an inactivity timer expires.

In an embodiment, the starting position of the on-duration timer for the next DRX cycle is determined based on the indication information in the first signaling.

In an embodiment, the starting position of the on-duration timer for the next DRX cycle is determined to be after (a time instant which is) a time duration after the slot or subframe in which receiving the first signaling.

In an embodiment, the starting position of the on-duration timer for the next DRX cycle is determined to be after (a time instant which is) the time duration after the slot or subframe where the predefined condition is satisfied.

In an embodiment of the predefined condition comprising not detecting the first signaling indicating starting the on-duration timer after a time duration during the time period, the starting position of the on-duration timer for the next DRX cycle is determined based on the first signaling or is determined as the time duration after receiving the first signaling if the first signaling indicating starting the on-duration timer after a time duration is detected in the time period, and the starting position of the on-duration timer for the next DRX cycle is determined based on a DRX configuration of the DRX if the predefined condition is satisfied.

In an embodiment, the predefined condition comprises receiving an enable signaling for enabling changing a start offset of the on-duration timer or for enabling monitoring the first signaling. In this embodiment, the starting position is determined by: if the first signaling indicating starting the on-duration timer after a duration is detected in the time period and the predefined condition is satisfied, the starting position of the on-duration timer for the next DRX cycle is determined based on the first signaling or is determined to be after the time duration after receiving the first signaling; otherwise, the starting position of the on-duration timer for the next DRX cycle is determined based on a DRX configuration of the DRX.

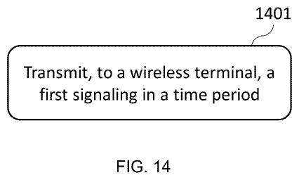

FIG. 14 shows a schematic diagram of a method according to an embodiment of the present disclosure. The method shown in FIG. 14 may be used in a wireless network node (e.g. BS) and comprises the following step.

Step 1401: Transmit, to a wireless terminal, a first signaling in a time period.

In this embodiment, the wireless network node transmits a first signaling in a time period to a wireless terminal (e.g. UE). Note that the first signaling is associated with determining a starting position of an on-duration timer of a DRX. That is, the wireless network node may transmit the first signaling in the time period to indicate the wireless terminal whether to start the on-duration timer (i.e. whether to enter the DRX on state/period).

In an embodiment, the time period is determined by a monitoring period indicating a cycle of the first signaling.

In an embodiment, the time period is determined by at least one of a first reference point, a first offset, a second reference point, a second offset, a window length, a timer, a jitter window, a jitter value, a PDB, a traffic information, a minimum time gap, or a monitoring pattern.

In an embodiment, the start of the time period is determined based on the first reference point and the first offset. In this embodiment, the first offset indicates a time duration between the starting point of the time period and the first reference point.

In an embodiment, the first reference point may be one of a beginning of a slot or a subframe or a millisecond at where the on-duration timer for the next DRX cycle starts, a last slot where the on-duration timer or an inactivity timer or a retransmission timer of the DRX expires, a system frame where the beginning of the slot at where the on-duration timer for the next DRX cycle starts, a system frame where a last slot of the on-duration timer or an inactivity timer of the DRX expires, X-th subframe of every Y-th system frame, where X is an integer greater than or equal to 0 and smaller than 10 and Y is an integer greater than or equal to 0 and smaller than 513, a system frame, a beginning of a system frame, an end of a system frame, an end of a slot at where the on-duration timer for the next DRX cycle starts, a slot or a subframe of a start of a jitter window, a slot or a subframe of an end of a jitter window, a slot or a subframe of a middle of a jitter window.

In an embodiment, the first offset is one of: a value smaller than or equal to half of the PDB, a value associated with a PDB value, a value associated with a traffic parameter in the traffic information, a value associated with a frames per second value, a value associated with a length of jitter window, a value associated with a PDU set, a value associated with a quality indicator of PDU set, a value associated with a quality of service parameter, a value associated with a traffic periodicity in the traffic information, a value smaller than or equal to half of a traffic periodicity comprised in the traffic information, a value smaller than or equal to a quotient of a division of 1000 by an FPS parameter comprised in the traffic information.

In an embodiment, the first offset has different values for different values of a quality of service parameter or a priority parameter comprised in the traffic information.

In an embodiment, an end of the time period is determined based on at least one of a second reference point, an second offset, a minimum time gap, a window length, a jitter range, a jitter window, or a number of monitor occasions of the first signaling.

In an embodiment, the second reference point comprises/is at least one of: a beginning of a slot or a subframe or a millisecond where the on-duration timer for the next DRX cycle starts, a last slot where the on-duration timer or an inactivity timer or a retransmission timer of the DRX expires, a system frame where a beginning of the slot at where the on-duration timer for the next DRX cycle starts; a system frame after a last slot before the on-duration timer or an inactivity timer of the DRX expires, X-th subframe of every Y-th system frame, where X is an integer greater than or equal to 0 and smaller than 10 and Y is an integer greater than or equal to 0 and smaller than 513, a system frame, a beginning of a system frame, an end of a system frame, an end of a slot at where the on-duration timer for the next DRX cycle starts, a slot or subframe of a start of the jitter window, a slot or subframe of a middle of the jitter window, a slot or subframe of an end of the jitter window.

In an embodiment, the end of the time period is determined by the second reference point and the second offset. In this embodiment, the second offset indicates a time duration between the second reference point and the end of the time period.

In an embodiment, the end of the time period is determined by the window length indicating a time duration from a start of the time period to the end of the time period.

In an embodiment, the window length is associated with at least one of: a PDB, a jitter range, a quality indicator of a PDU set, or traffic information.

In an embodiment, the wireless network node may not transmit the first signaling after a fixed number of monitoring occasions of the first signaling in the time period have passed. In an embodiment, a unit of the time period is a slot or a millisecond.

In an embodiment, the wireless network node transmits the first signaling in the time period according to a monitoring pattern.

In an embodiment, the monitoring pattern indicates a monitoring cycle. In this embodiment, the wireless network node transmits the first signaling in a time-domain position if (SFN*10+subframe number) mod(monitoring cycle)=I, where SFN is a system frame number corresponding to the time-domain position, subframe number is a subframe index corresponding to the time-domain position, and I is an integer greater than or equal to 0 and smaller than the monitoring cycle.

In an embodiment, the monitoring pattern comprises a bitmap. Each bit in the bitmap indicate whether at least one time interval in the time period is valid for monitoring the first signaling. For example, the time interval in time period may be slot or millisecond. Based on the monitoring pattern of this embodiment, the wireless network node transmits the first signaling in the valid time interval(s).

In an embodiment, the first signaling is DCI, a sequence based signaling or a reference signal.

In an embodiment, the first signaling comprises indication information for at least one of: whether to start the on-duration timer, whether to start the on-duration timer after a time duration, a time duration associated with starting the on-duration timer based on the first signaling or in response to the predefined condition, a temporary offset used to determine when to start the on-duration timer, a change offset used to determine a start offset associated with the on-duration timer, when to start the on-duration timer, or a search space set group index.

In an embodiment, the time duration is a predefined value, indicated by the first signaling or configured by a high layer signaling.

In an embodiment, the time duration is associated with a sub-carrier spacing, is a minimum time gap, is a second offset used for determining (the end of) the time period or is 0.

In an embodiment, the high layer signaling configures a list of candidate values for the time duration.

In an embodiment, the first signaling is DCI and is associated with at least one configuration parameter comprising at least one of a search space set, an RNTI, a start position of the indication information of the first signaling, a DCI size of the first signaling, an enable signaling, a QCL or a TCI state.

In an embodiment, the at least one configuration parameter is configured by a high layer signaling.

In an embodiment, there is at least one limitation on the configuration parameter(s) of the search space set. The at least one limitation can be referred to the above embodiments related to the first threshold A, the second threshold B, the third threshold C, the fourth threshold D, the fifth threshold E, the sixth threshold F, the seventh threshold G and the eighth threshold H.

In an embodiment, the RNTI associated with the first signaling (i.e. DCI) is used for at least one of: DCI associated with traffics of an extended reality service, DCI associated with an extended reality service, DCI indicating whether there is a traffic of extended reality service for the next DRX long cycle, DCI indicating whether to start the on-duration timer, DCI indicating whether to start the on-duration timer after the time duration, DCI indicating a time duration, a temporary offset or a change offset, DCI indicating whether to change a start offset associated with the on-duration timer, DCI indicating whether to monitor the DCI in a subsequent monitoring occasion.

In an embodiment of the first signaling being configured, the number of sizes of DCI formats for PDCCH candidates in the serving cell is up to 5, and the number of sizes of DCI formats having a cyclic redundancy check scrambled by a cell radio network temporary identifier in the serving cell is up to 3.

In an embodiment, at least one of the starting position of the indication information in the first signaling and a DCI size of the first signaling is indicated by a high layer signaling. In this embodiment, one or more bits in a block in the first signaling indicates the indication information for one or more wireless terminals in a group.

In an embodiment, the first signaling is the DCI format 2_6 scrambled with the RNTI.

In an embodiment, different monitor occasions for the first signaling in a time interval are associated with a plurality of transmission relations (e.g. QCL, TCI states, CORESETs and/or SSBs).

In an embodiment, the time interval is/comprises at least one search space set cycle, at least one slot, or the time period.

In an embodiment, each monitor occasion comprises one or more consecutive slots, one or more consecutive symbols, or one or more consecutive search space set cycles.

In an embodiment, one or more consecutive monitor occasions are grouped as a monitor occasion group associated with the same transmission relation.

In an embodiment, each monitor occasion or each monitor occasion group is configured, by a high layer signaling, to be associated with one transmission relation.

In an embodiment, the transmission relation associated with each monitor occasion or each monitor occasion group is determined based on a transmission relation list configured in a search space set of the first signaling.

In an embodiment, the monitor occasions in one time interval are divided into X groups, wherein X is the number of transmission relations in the transmission relation list.

In an embodiment, a first monitor occasion in the time interval is associated with a first transmission relation of a search space set of the first signaling and the remaining monitor occasions in the time interval are associated with at least one second transmission relation different from the first transmission relation.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a wireless terminal, the method comprising:
performing a discontinuous reception (DRX) to monitor a physical downlink control channel (PDCCH),
determining a starting position of an on-duration timer for a next DRX cycle according to at least one of a first signaling or to a predefined condition, and
activating the on-duration timer at the starting position that is determined,
wherein the first signaling is monitored in a time period.

2. The wireless communication method of claim 1, wherein the time period is determined by at least one of a monitoring period indicating a cycle of the first signaling, a first reference point, a first offset, a second reference point, a second offset, a window length, a timer, a jitter window, a jitter value, a packet delay budget (PDB), a traffic information, a minimum time gap, or a monitoring pattern.

3. (canceled)

4. The wireless communication method of claim 1, wherein
a start of the time period is determined based on a first reference point and a first offset, and
wherein the first offset indicates a time duration between the starting point of the time period and the first reference point; and
the first reference point comprises at least one of: a beginning of a slot or a subframe or a millisecond at where the on-duration timer for the next DRX cycle starts, a last slot where the on-duration timer or an inactivity timer or a retransmission timer of the DRX expires, a system frame where the beginning of the slot at where the on-duration timer for the next DRX cycle starts, a system frame where a last slot of the on-duration timer or an inactivity timer of the DRX expires, X-th subframe of every Y-th system frame, where X is an integer greater than or equal to 0 and smaller than 10 and Y is an integer greater than or equal to 0 and smaller than 513, a system frame, a beginning of a system frame, an end of a system frame, an end of a slot at where the on-duration timer for the next DRX cycle starts, a slot or a subframe of a start of a jitter window, a slot or a subframe of an end of a jitter window, or a slot or a subframe of a middle of a jitter window.

5-6. (canceled)

7. The wireless communication method of claim 2, wherein the first offset has different values for different values of a quality of service parameter or a priority parameter comprised in the traffic information.

8. The wireless communication method of claim 1, wherein an end of the time period is determined based on at least one of a second reference point, an second offset, a minimum time gap, a window length, a jitter range, a jitter window, or a number of monitor occasions of the first signaling; and
wherein the second reference point comprises at least one of: a beginning of a slot or a subframe or a millisecond where the on-duration timer for the next DRX cycle starts, a last slot where the on-duration timer or an inactivity timer or a retransmission timer of the DRX expires, a system frame where a beginning of the slot at where the on-duration timer for the next DRX cycle starts; a system frame after a last slot before the on-duration timer or an inactivity timer of the DRX expires, X-th subframe of every Y-th system frame, where X is an integer greater than or equal to 0 and smaller than 10 and Y is an integer greater than or equal to 0 and smaller than 513, a system frame, a beginning of a system frame, an end of a system frame, an end of a slot at where the on-duration timer for the next DRX cycle starts, a slot or subframe of a start of the jitter window, a slot or subframe of a middle of the jitter window, a slot or subframe of an end of the jitter window; and
wherein the window length is associated with at least one of: a packet delay budget, PDB, a jitter range, a quality indicator of a protocol data unit set, or traffic information.

9. (canceled)

10. The wireless communication method of claim 8, wherein the end of the time period is determined by the second reference point and the second offset, and
wherein the second offset indicates a time duration between the second reference point and the end of the time period.

11-14. (canceled)

15. The wireless communication method of claim 1, further comprising:
monitoring the first signaling in the time period according to a monitoring pattern; and
wherein the monitoring pattern comprises a bitmap, wherein each bit in the bitmap indicate whether at least one time interval in the time period is valid for monitoring the first signaling, wherein monitoring the first signaling in the time period according to the monitoring pattern comprises: monitoring the first signaling in a valid time interval.

16. The wireless communication method of claim 15, wherein the monitoring pattern indicates a monitoring cycle,
wherein monitoring the first signaling in the time period according to the monitoring pattern comprises:
monitoring the first signaling in a time-domain position if (SFN*10+subframe number) mod (monitoring cycle)=I,
where SFN is a system frame number corresponding to the time-domain position, subframe number is a subframe index corresponding to the time-domain position, and I is an integer greater than or equal to 0 and smaller than the monitoring cycle.

17. (canceled)

18. The wireless communication method of claim 1, wherein
the first signaling is downlink control information (DCI), a sequence based signaling or a reference signal; and
the first signaling comprises indication information for at least one of: whether to start the on-duration timer, whether to start the on-duration timer after a time duration, a time duration associated with starting the on-duration timer based on the first signaling or in response to the predefined condition, a temporary offset used to determine when to start the on-duration timer, a change offset used to determine a start offset associated with the on-duration timer, when to start the on-duration timer, or a search space set group index.

19-22. (canceled)

23. The wireless communication method of claim 18, wherein
the first signaling is DCI and is associated with at least one configuration parameter comprising at least one of a search space set, a radio network temporary identifier (RNTI), a start position of the indication information of the first signaling, a DCI size of the first signaling, an enable signaling, a quasi-co-location (QCL), or a transmission configuration indicator (TCI) state; and
the at least one configuration parameter of the search space set is limited by at least one of: the number of search space sets used for the first signaling is not larger than a first threshold, wherein the first threshold is an integer greater than 0 and smaller than 3, a duration of the search space set used for the first signaling is not larger than a second threshold, wherein the second threshold is an integer greater than 0 and smaller than 30, a periodicity of the search space set used for the first signaling is not smaller than a third threshold, wherein the third threshold is an integer greater than 1, a number of aggregation levels of the search space set used for the first signaling is not larger than a fourth threshold, wherein the fourth threshold is an integer greater than 0 and smaller than 3, a maximum of an aggregation level of the search space set used for the first signaling is not larger than a fifth threshold, wherein the fifth threshold is an integer greater than 0 and smaller than 8, a number of PDCCH candidates per aggregation level of the search space set used for the first signaling is not larger than a sixth threshold, wherein the sixth threshold has the same value or different values for different aggregation levels, a total number of PDCCH candidates of the search space set used for the first signaling is not larger than a seventh threshold, wherein the seventh threshold is an integer greater than 0 and smaller than 20, or a number of monitoring occasions in single slot of the search space set used for the first signaling is not larger than an eighth threshold, wherein the eighth threshold is an integer greater than 0 and less than 3.

24-29. (canceled)

30. The wireless communication method of claim 23, wherein different monitor occasions for the first signaling in a time interval are associated with a plurality of transmission relations.

31. The wireless communication method of claim 30, wherein
the time interval comprises at least one search space set cycle, at least one slot, or the time period; and/or
the monitor occasions in one time interval are divided into X groups, wherein X is the number of transmission relations in the transmission relation list; and/or
a first monitor occasion in the time interval is associated with a first transmission relation of a search space set of the first signaling and the remaining monitor occasions in the time interval are associated with at least one second transmission relation different from the first transmission relation.

32. The wireless communication method of claim 30, wherein
each monitor occasion comprises one or more consecutive slots, one or more consecutive symbols, or one or more consecutive search space set cycles, or
wherein one or more consecutive monitor occasions are grouped as a monitor occasion group associated with the same transmission relation; and
each monitor occasion or each monitor occasion group is configured, by a high layer signaling, to be associated with a transmission relation; and
the transmission relation associated with each monitor occasion or each monitor occasion group is determined based on a transmission relation list configured in a search space set of the first signaling; and
the transmission relation is associated with at least one of a quasi-co-location, a control resource set (CORESET), a transmission configuration indicator (TCI) state, or a synchronization signal block.

33-37. (canceled)

38. The wireless communication method of claim 1, further comprising:
monitoring the first signaling if:
at least part of the time period is outside of an active time of the DRX,
a search space is configured for the first signaling,
receiving, from the wireless network, an enable signaling or an activation signaling monitoring the first signaling,
outside of an active time of the DRX,
within the time period,
another first signaling indicating continuing to monitor the first signaling was received, or
not receiving the first signaling which indicates starting the on-duration timer after a time duration.

39. (canceled)

40. The wireless communication method of claim 1, wherein the predefined condition comprises at least one of:
not detecting the first signaling indicating starting the on-duration timer after a time duration during the time period,
receiving an enable signaling for enabling changing a start offset of the on-duration timer,
receiving an enable signaling for enabling monitoring the first signaling,
reporting a capability signaling indicating a support of monitoring the first signaling,
a timer expires, wherein the timer is triggered under at least one of following conditions:
if receiving scheduling DCI,
if receiving scheduling DCI for XR service traffic,
if receiving the first signaling,
if receiving a first kind of DCI format,
at a first slot outside of an active time of the DRX, or
at a first slot after the on-duration timer or an inactivity timer expires,
the timer expires and not receiving a traffic during the timer running,
receiving a first kind of DCI format, wherein the first kind of DCI format includes at least one of: a DCI used for XR service traffic, a DCI format 0_1, a DCI format 1_1, a DCI format 0_2, a DCI format 1_2, or a DCI format 2_6,
receiving DCI scrambled with a first kind of RNTI, wherein the first kind of RNTI includes at least one of:
an RNTI used for DCI associated with traffics of an extended reality service,
an RNTI used for DCI indicating whether to start the on-duration timer,
an RNTI used for DCI indicating whether to start the on-duration timer after the time duration,
an RNTI used for DCI indicating whether to change a start offset associated with the on-duration timer,
an RNTI used for DCI indicating whether to monitor the DCI in a subsequent monitoring occasion,
a power saving RNTI,
a cell RNTI,
a configured scheduling RNTI, or
a modulation and coding scheme cell RNTI.

41. The wireless communication method of claim 1, wherein
determining the starting position of the on-duration timer for the next DRX cycle according to the first signaling comprises:
determining the starting position of the on-duration timer for the next DRX cycle based on the indication information in the first signaling, or
determining that the starting position of the on-duration timer for the next DRX cycle is after a time duration after the slot or subframe in which receiving the first signaling; or
determining the starting position of the on-duration timer for the next DRX cycle according to a predefined condition comprises: determining that the starting position of the on-duration timer for the next DRX cycle is after the time duration after the slot or subframe where the predefined condition is satisfied.

42-43. (canceled)

44. The wireless communication method of claim 1, wherein the predefined condition comprises receiving an enable signaling for enabling changing a start offset of the on-duration timer or for enabling monitoring the first signaling,
wherein the starting position is determined by:
if the first signaling indicating starting the on-duration timer after a duration is detected in the time period and the predefined condition is satisfied, the starting position of the on-duration timer for the next DRX cycle is determined based on the first signaling or is determined as the time duration after receiving the first signaling,
otherwise, the starting position of the on-duration timer for the next DRX cycle is determined based on a DRX configuration of the DRX.

45. A wireless communication method for use in a wireless network node, the method comprising:
transmitting, to a wireless terminal, a first signaling in a time period,
wherein the first signaling is associated with determining a starting position of an on-duration timer of a discontinuous reception (DRX).

46-80. (canceled)

81. A wireless terminal, comprising:
a communication unit, and
a processor, configured to:
use the communication unit to perform a discontinuous reception (DRX) to monitor a physical downlink control channel (PDCCH)
determine a starting position of an on-duration timer for a next DRX cycle according to at least one of a first signaling or to a predefined condition, and
activate the on-duration timer at the determined starting position,
wherein the first signaling is monitored in a time period.

82. (canceled)

83. A wireless network node, comprising:
a communication unit, configured to perform the wireless communication method according to claim 45.

84-85. (canceled)
